(19) United States
(12) Patent Application Publication
(10) Pub. No.: US 2019/0174378 A1
(43) Pub. Date: Jun. 6, 2019

(54) METHOD FOR EXECUTION OF RANDOM ACCESS, USER EQUIPMENT, AND BASE STATION

(71) Applicants: Sharp Kabushiki Kaisha, Sakai City, Osaka (JP); FG Innovation Company Limited, Hongkong (CN)

(72) Inventors: NINGJUAN CHANG, Pudong Shanghai (CN); SHOHEI YAMADA, Sakai City (JP); RENMAO LIU, Pudong Shanghai (CN)

(21) Appl. No.: 16/325,142

(22) PCT Filed: Aug. 11, 2017
(86) PCT No.: PCT/CN2017/097119

§ 371 Date: Feb. 12, 2019

(30) Foreign Application Priority Data
Aug. 12, 2016 (CN) 201610664461.8

(51) Int. Cl. H04W 36/08; H04W 74/08; H04W 72/04; H04W 4/80; H04W 8/08; H04W 76/27; H04W 88/02

(52) U.S. Cl. CPC H04W 36/08; H04W 74/0866; H04W 74/0833; H04W 72/0453; H04W 88/023; H04W 4/80; H04W 8/08; H04W 76/27; H04W 72/042

(57) ABSTRACT

The present invention provides a method for execution of random access at a user equipment (UE), comprising: receiving a handover command message from a source base station, the handover command message comprising information about a target anchor carrier; determining whether to use the target anchor carrier or a non-anchor carrier for random access based on the handover command message; and performing random access by using the target anchor carrier or the non-anchor carrier according to the determination result. The present invention also provides a method for execution of random access at a source base station, a method for execution of random access at a target base station, and a corresponding UE, a corresponding source base station, and a corresponding target base station.

### TECHNICAL FIELD

The present invention relates to the technical field of wireless communications. In particular, the present invention relates to a method for execution of random access, a corresponding user equipment (UE), and a corresponding base station.

### BACKGROUND

With the extensive application of the Internet of Things (IoT) and its terminal devices, it becomes crucial to address the matter of designing a wireless network technology adapted for the communication of the IoT. The 3rd Generation Partnership Project (3GPP) is currently developing a new access system for the purpose of designing a wireless access technology with low complexity and low throughput to meet the needs of the wireless IoT, which is called the Narrowband-IoT (NB-IoT). The goal is to design a wireless access technology with low complexity and low throughput to meet the needs of the wireless IoT. The features of this access technology include: supporting a large number of devices with low throughput, low latency sensitivity, ultra-low device cost, ultra-low power consumption, and optimized network architecture.

In NB-IoT, such a UE supporting low throughput and having ultra-low device cost and ultra-low power consumption can only operate at a 180 kHz network bandwidth, i.e., one physical resource block (PRB) in the Long Term Evolution (LTE), which is referred to as a carrier; and such a UE has to support three modes of operation (deployment modes): a stand-alone mode of operation, a guard-band mode of operation, and an in-band mode of operation. The stand-alone mode of operation is to implement NB-IoT on the existing GSM frequency band, i.e., using the operating frequency band of an existing GERAN system and a scattering frequency band potentially deployed by the IoT. The guard-band mode of operation implements NB-IoT in the guard band of one LTE carrier, i.e., using a frequency band in the LTE frequency band that is used as the guard band. The in-band mode of operation implements NB-IoT in the existing LTE frequency band, i.e., using the frequency band in the LTE frequency band for actual transmission. Different bearer modes may use different physical parameters and processing mechanisms.

In Release 13, carriers of NB-IoT are divided into two types: anchor carriers and non-anchor carriers. An anchor carrier is defined as a carrier that a UE assumes to transmit data related to NB-IoT, such as a Physical Broadcast Channel (PBCH), a Primary Synchronization Signal (PSS)/Secondary Synchronization Signal (SSS), or a System Information Block (SIB). A non-anchor carrier is defined as a carrier that a UE assumes not to transmit data related to NB-IoT, such as a PBCH, a PSS, an SSS, or an SIB. That is, a UE considers that a non-anchor carrier is only used to receive or send data for unicast transmission related to NB-IoT, such as a Physical Downlink Control Channel (PDCCH), a Physical Downlink Shared Channel (PDSCH), or a Physical Uplink Shared Channel (PUSCH). When an eNB does not configure a non-anchor carrier for a UE, an anchor carrier may also be used by the UE to receive or send data for unicast transmission related to NB-IoT, such as a PDCCH, a PDSCH, or a PUSCH. An eNB may configure a non-anchor carrier for a UE through a radio resource control (RRC) connection establishment message, an RRC connection reestablishment message, an RRC connection reconfiguration message, an RRC connection resume message, or the like.

In Release 13 NB-IoT, a UE performs a random access process only on the anchor carrier. After a base station (an eNB) configures a non-anchor carrier for a UE, the UE will operate on the non-anchor carrier in an RRC connection process until the UE needs to perform random access or until another non-anchor carrier is allocated to the UE. When the UE operating on the non-anchor carrier needs to perform random access, the UE will return to an anchor carrier to perform random access.

A new Release 14 NB-IoT project was approved at the 3GPP RAN#72 Conference. The goal of the project was to enhance the Release 13 NB-IoT, including supporting random access on a non-anchor carrier. The prior art does not provide a solution regarding how to support random access on a non-anchor carrier.

### SUMMARY OF INVENTION

In order to solve the above-mentioned technical problem, the present invention proposes a solution regarding how to support random access on a non-anchor carrier.

According to a first aspect of the present invention, a method for execution of random access at a UE is provided. The method comprises: receiving a handover command message from a source base station, the handover command message comprising information about a target anchor carrier; determining whether to use the target anchor carrier or a non-anchor carrier for random access based on the handover command message; and performing random access by using the target anchor carrier or the non-anchor carrier according to the determination result.

In one embodiment, the determining whether to use the target anchor carrier or a non-anchor carrier for random access based on the handover command message comprises: if the handover command message does not comprise non-anchor carrier configuration information about a target non-anchor carrier, determining to use the target anchor carrier for random access.

In one embodiment, the determining whether to use the target anchor carrier or a non-anchor carrier for random access based on the handover command message comprises: if the handover command message comprises non-anchor carrier configuration information about a target non-anchor carrier and the handover command message or target cell system information does not comprise random access configuration information corresponding to the target non-anchor carrier, determining to use the target anchor carrier for random access.

In one embodiment, the determining whether to use the target anchor carrier or a non-anchor carrier for random access based on the handover command message comprises: if the handover command message comprises non-anchor carrier configuration information about a target non-anchor carrier and the target non-anchor carrier indicated by the non-anchor carrier configuration information does not support random access, determining to use the target anchor carrier for random access.

In one embodiment, the determining whether to use the target anchor carrier or a non-anchor carrier for random access based on the handover command message comprises: if the handover command message comprises non-anchor carrier configuration information about a target non-anchor carrier and the handover command message or target cell system information comprises random access configuration information corresponding to the target non-anchor carrier, determining to use the target non-anchor carrier for random access.

In one embodiment, the determining whether to use the target anchor carrier or a non-anchor carrier for random access based on the handover command message comprises: if the handover command message comprises non-anchor carrier configuration information about a target non-anchor carrier and the target non-anchor carrier indicated by the non-anchor carrier configuration information supports random access, determining to use the target non-anchor carrier for random access.

In one embodiment, the determining whether to use the target anchor carrier or a non-anchor carrier for random access based on the handover command message comprises: if the handover command message comprises non-anchor carrier configuration information about a target non-anchor carrier, determining to use the target non-anchor carrier for random access.

In one embodiment, the determining whether to use the target anchor carrier or a non-anchor carrier for random access based on the handover command message comprises: if the handover command message comprises non-anchor carrier configuration information about a target non-anchor carrier, the handover command message or target cell system information indicates that the target anchor carrier does not support random access, and the non-anchor carrier configuration information indicates that the target non-anchor carrier does not support random access, selecting one non-anchor carrier for random access from one or more carriers supporting random access.

In one embodiment, the determining whether to use the target anchor carrier or a non-anchor carrier for random access based on the handover command message comprises: if the handover command message does not comprise non-anchor carrier configuration information about a target non-anchor carrier and/or the handover command message or target cell system information indicates that the target anchor carrier does not support random access, selecting one non-anchor carrier for random access from one or more carriers supporting random access.

In one embodiment, the determining whether to use the target anchor carrier or a non-anchor carrier for random access based on the handover command message comprises: if the handover command message comprises non-anchor carrier configuration information about a target non-anchor carrier and the handover command message or target cell system information does not comprise random access configuration information corresponding to the target non-anchor carrier, selecting one non-anchor carrier for random access from one or more carriers supporting random access.

In one embodiment, the determining whether to use the target anchor carrier or a non-anchor carrier for random access based on the handover command message comprises: if the handover command message comprises non-anchor carrier configuration information about a target non-anchor carrier and the target non-anchor carrier does not support random access, selecting one non-anchor carrier for random access from one or more carriers supporting random access.

In one embodiment, the non-anchor carrier configuration information is contained in a radioresource-configdedicated information element or a physicalconfig-dedicated information element of the handover command message.

In one embodiment, the handover command message is an RRC connection reconfiguration message comprising mobility control information.

In one embodiment, if the handover command message comprises RACH-ConfigDedicated configuration information, then the RACH-ConfigDedicated configuration information is valid for a determined target anchor carrier or non-anchor carrier. The performing random access by using the target anchor carrier or the non-anchor carrier according to the determination result comprises: sending a preamble and/or an MSG3 message to a target base station on an uplink carrier associated with the determined target anchor carrier or non-anchor carrier; and receiving an RAR and/or an MSG4 message from the target base station on a downlink carrier associated with the determined target anchor carrier or non-anchor carrier.

According to a second aspect of the present invention, a method for execution of random access at a source base station is provided. The method comprises: generating a handover command message, the handover command message comprising information about a target anchor carrier, or the handover command message comprising the information about the target anchor carrier and non-anchor carrier configuration information about a target non-anchor carrier; and sending the handover command message to a UE, so that the UE performs random access by using the target anchor carrier, the target non-anchor carrier, or a non-anchor carrier selected from one or more carriers supporting random access.

In one embodiment, the non-anchor carrier configuration information is contained in a radioresource-configdedicated information element or a physicalconfig-dedicated information element of the handover command message.

In one embodiment, the handover command message is an RRC connection reconfiguration message comprising mobility control information.

According to a third aspect of the present invention, a method for execution of random access at a target base station is provided. The method comprises: determining whether to receive random access from a UE on a target anchor carrier or a non-anchor carrier based on handover related information, the handover related information comprising information about the target anchor carrier; and receiving or responding to the random access from the UE on the target anchor carrier or the non-anchor carrier according to the determination result.

In one embodiment, the determining whether to receive random access from a UE on a target anchor carrier or a non-anchor carrier based on handover related information comprises: if the handover related information does not comprise non-anchor carrier configuration information about a target non-anchor carrier, determining to receive or respond to the random access on the target anchor carrier.

In one embodiment, the determining whether to receive random access from a UE on a target anchor carrier or a non-anchor carrier based on handover related information comprises: if a handover command message comprises non-anchor carrier configuration information about a target non-anchor carrier and the handover related information or target cell system information does not comprise random access configuration information corresponding to the target non-anchor carrier, determining to receive or respond to the random access on the target anchor carrier.

In one embodiment, the determining whether to receive random access from a UE on a target anchor carrier or a non-anchor carrier based on handover related information comprises: if the handover related information comprises non-anchor carrier configuration information about a target non-anchor carrier and the target non-anchor carrier indicated by the non-anchor carrier configuration information does not support random access, determining to receive or respond to the random access on the target anchor carrier.

In one embodiment, the determining whether to receive random access from a UE on a target anchor carrier or a non-anchor carrier based on handover related information comprises: if the handover related information comprises non-anchor carrier configuration information about a target non-anchor carrier and the handover related information or target cell system information comprises random access configuration information corresponding to the target non-anchor carrier, determining to receive or respond to the random access on the target non-anchor carrier.

In one embodiment, the determining whether to receive random access from a UE on a target anchor carrier or a non-anchor carrier based on handover related information comprises: if a handover command message comprises non-anchor carrier configuration information about a target non-anchor carrier and the target non-anchor carrier indicated by the non-anchor carrier configuration information supports random access, determining to receive or respond to the random access on the target non-anchor carrier.

In one embodiment, the determining whether to receive random access from a UE on a target anchor carrier or a non-anchor carrier based on handover related information comprises: if a handover command message comprises non-anchor carrier configuration information about a target non-anchor carrier, determining to receive or respond to the random access on the target non-anchor carrier.

In one embodiment, the determining whether to receive random access from a UE on a target anchor carrier or a non-anchor carrier based on handover related information comprises: if the handover related information comprises non-anchor carrier configuration information about a target non-anchor carrier, the handover related information or target cell system information indicates that the target anchor carrier does not support random access, and the non-anchor carrier configuration information indicates that the target non-anchor carrier does not support random access, receiving or responding to the random access on one non-anchor carrier supporting random access.

In one embodiment, the determining whether to receive random access from a UE on a target anchor carrier or a non-anchor carrier based on handover related information comprises: if the handover related information does not comprise non-anchor carrier configuration information about a target non-anchor carrier and/or a handover command message or target cell system information indicates that the target anchor carrier does not support random access, receiving or responding to the random access on one non-anchor carrier supporting random access.

In one embodiment, the determining whether to receive random access from a UE on a target anchor carrier or a non-anchor carrier based on handover related information comprises: if the handover related information comprises non-anchor carrier configuration information about a target non-anchor carrier and the handover related information or target cell system information does not comprise random access configuration information corresponding to the target non-anchor carrier, receiving or responding to the random access on one non-anchor carrier supporting random access.

In one embodiment, the determining whether to receive random access from a UE on a target anchor carrier or a non-anchor carrier based on handover related information comprises: if a handover command message comprises non-anchor carrier configuration information about a target non-anchor carrier and the target non-anchor carrier does not support random access, receiving or responding to the random access on one non-anchor carrier supporting random access.

In one embodiment, if the handover command message comprises RACH-ConfigDedicated configuration information, then the RACH-ConfigDedicated configuration information is valid for a determined target anchor carrier or non-anchor carrier. The receiving or responding to the random access from the UE on the target anchor carrier or the non-anchor carrier according to the determination result comprises: receiving a preamble and/or an MSG3 message from the UE on an uplink carrier associated with the determined target anchor carrier or non-anchor carrier; and sending an RAR and/or an MSG4 message to the UE on a downlink carrier associated with the determined target anchor carrier or non-anchor carrier.

According to a fourth aspect of the present invention, a UE is provided. The UE comprises: a receiving unit for receiving a handover command message from a source base station, the handover command message comprising information about a target anchor carrier; a determining unit for determining whether to use the target anchor carrier or a non-anchor carrier for random access based on the handover command message; and a random access executing unit for performing random access by using the target anchor carrier or the non-anchor carrier according to a determination result.

In one embodiment, the determining unit is further used for: if the handover command message does not comprise non-anchor carrier configuration information about a target non-anchor carrier, determining to use the target anchor carrier for random access.

In one embodiment, the determining unit is further used for: if the handover command message comprises non-anchor carrier configuration information about a target non-anchor carrier and the handover command message or target cell system information does not comprise random access configuration information corresponding to the target non-anchor carrier, determining to use the target anchor carrier for random access.

In one embodiment, the determining unit is further used for: if the handover command message comprises non-anchor carrier configuration information about a target non-anchor carrier and the target non-anchor carrier indicated by the non-anchor carrier configuration information does not support random access, determining to use the target anchor carrier for random access.

In one embodiment, the determining unit is further used for: if the handover command message comprises non-anchor carrier configuration information about a target non-anchor carrier and the handover command message or target cell system information comprises random access configuration information corresponding to the target non-anchor carrier, determining to use the target non-anchor carrier for random access.

In one embodiment, the determining unit is further used for: if the handover command message comprises non-anchor carrier configuration information about a target non-anchor carrier and the target non-anchor carrier indicated by the non-anchor carrier configuration information supports random access, determining to use the target non-anchor carrier for random access.

In one embodiment, the determining unit is further used for: if the handover command message comprise non-anchor carrier configuration information about a target non-anchor carrier, determining to use the target non-anchor carrier for random access.

In one embodiment, the determining unit is further used for: if the handover command message comprises non-anchor carrier configuration information about a target non-anchor carrier, the handover command message or target cell system information indicates that the target anchor carrier does not support random access, and the non-anchor carrier configuration information indicates that the target non-anchor carrier does not support random access, selecting one non-anchor carrier for random access from one or more carriers supporting random access.

In one embodiment, the determining unit is further used for: if the handover command message does not comprise non-anchor carrier configuration information about a target non-anchor carrier and/or the handover command message or target cell system information indicates that the target anchor carrier does not support random access, selecting one non-anchor carrier for random access from one or more carriers supporting random access.

In one embodiment, the determining unit is further used for: if the handover command message comprises non-anchor carrier configuration information about a target non-anchor carrier and the handover command message or target cell system information does not comprise random access configuration information corresponding to the target non-anchor carrier, selecting one non-anchor carrier for random access from one or more carriers supporting random access.

In one embodiment, the determining unit is further used for: if the handover command message comprises non-anchor carrier configuration information about a target non-anchor carrier and the target non-anchor carrier does not support random access, selecting one non-anchor carrier for random access from one or more carriers supporting random access.

In one embodiment, the non-anchor carrier configuration information is contained in a radioresource-configdedicated information element or a physicalconfig-dedicated information element of the handover command message.

In one embodiment, the handover command message is an RRC connection reconfiguration message comprising mobility control information.

In one embodiment, if the handover command message comprises RACH-ConfigDedicated configuration information, then the RACH-ConfigDedicated configuration information is valid for a determined target anchor carrier or non-anchor carrier; and the random access executing unit is further used for: sending a preamble and/or an MSG3 message to a target base station on an uplink carrier associated with the determined target anchor carrier or non-anchor carrier; and receiving an RAR and/or an MSG4 message from the target base station on a downlink carrier associated with the determined target anchor carrier or non-anchor carrier.

According to a fifth aspect of the present invention, a source base station is provided. The source base station comprises: a generating unit for generating a handover command message, the handover command message comprising information about a target anchor carrier, or the handover command message comprising the information about the target anchor carrier and non-anchor carrier configuration information about a target non-anchor carrier; and a sending unit for sending the handover command message to a UE, so that the UE performs random access by using the target anchor carrier, the target non-anchor carrier, or a non-anchor carrier selected from one or more carriers supporting random access.

In one embodiment, the non-anchor carrier configuration information is contained in a radioresource-configdedicated information element or a physicalconfig-dedicated information element of the handover command message.

In one embodiment, the handover command message is an RRC connection reconfiguration message comprising mobility control information.

According to a sixth aspect of the present invention, a target base station is provided. The target base station comprises: a determining unit for determining whether to receive random access from a UE on a target anchor carrier or a non-anchor carrier based on handover related information, the handover related information comprising information about the target anchor carrier; and a random access executing unit for receiving or responding to the random access from the UE on the target anchor carrier or the non-anchor carrier according to a determination result.

In one embodiment, the determining unit is further used for: if the handover related information does not comprise non-anchor carrier configuration information about a target non-anchor carrier, determining to receive or respond to the random access on the target anchor carrier.

In one embodiment, the determining unit is further used for: if a handover command message comprises non-anchor carrier configuration information about a target non-anchor carrier and the handover related information or target cell system information does not comprise random access configuration information corresponding to the target non-anchor carrier, determining to receive or respond to the random access on the target anchor carrier.

In one embodiment, the determining unit is further used for: if the handover related information comprises non-anchor carrier configuration information about a target non-anchor carrier and the target non-anchor carrier indicated by the non-anchor carrier configuration information does not support random access, determining to receive or respond to the random access on the target anchor carrier.

In one embodiment, the determining unit is further used for: if the handover related information comprises non-anchor carrier configuration information about a target non-anchor carrier and the handover related information or target cell system information comprises random access configuration information corresponding to the target non-anchor carrier, determining to receive or respond to the random access on the target non-anchor carrier.

In one embodiment, the determining unit is further used for: if the handover command message comprises non-anchor carrier configuration information about a target non-anchor carrier and the target non-anchor carrier indicated by the non-anchor carrier configuration information supports random access, determining to receive or respond to the random access on the target non-anchor carrier.

In one embodiment, the determining unit is further used for: if a handover command message comprises non-anchor carrier configuration information about a target non-anchor carrier, determining to receive or respond to the random access on the target non-anchor carrier.

In one embodiment, the determining unit is further used for: if the handover related information comprises non-anchor carrier configuration information about a target non-anchor carrier, the handover related information or target cell system information indicates that the target anchor carrier does not support random access, and the non-anchor carrier configuration information indicates that the target non-anchor carrier does not support random access, receiving or responding to the random access on one non-anchor carrier supporting random access.

In one embodiment, the determining unit is further used for: if the handover related information does not comprise non-anchor carrier configuration information about a target non-anchor carrier and/or a handover command message or target cell system information indicates that the target anchor carrier does not support random access, receiving or responding to the random access on one non-anchor carrier supporting random access.

In one embodiment, the determining unit is further used for: if the handover related information comprises non-anchor carrier configuration information about a target non-anchor carrier and the handover related information or target cell system information does not comprise random access configuration information corresponding to the target non-anchor carrier, receiving or responding to the random access on one non-anchor carrier supporting random access.

In one embodiment, the determining unit is further used for: if a handover command message comprises non-anchor carrier configuration information about a target non-anchor carrier and the target non-anchor carrier does not support random access, receiving or responding to the random access on one non-anchor carrier supporting random access.

In one embodiment, if the handover command message comprises RACH-ConfigDedicated configuration information, then the RACH-ConfigDedicated configuration information is valid for a determined target anchor carrier or non-anchor carrier; and the random access executing unit is further used for: receiving a preamble and/or an MSG3 message from the UE on an uplink carrier associated with the determined target anchor carrier or non-anchor carrier; and sending an RAR and/or an MSG4 message to the UE on a downlink carrier associated with the determined target anchor carrier or non-anchor carrier.

With reference to the description and accompanying drawings hereinafter, the specific embodiments of the present invention are described in detail; and the manners in which the principle of the present invention is employed are illustrated. It should be understood that the embodiments of the present invention are not limited in scope. Within the spirit and scope defined by the appended claims, the embodiments of the present invention may include various variations, modifications, and equivalents.

The features described and/or illustrated with respect to a specific embodiment may be used in one or more other embodiments in the same or similar manner, or may be combined with the features in other embodiments, or may be used to replace the features in other embodiments.

It should be particularly noted that the term “comprise/include” used herein in this text refer to the existence of the features, whole pieces, steps, or components, but do not exclude the existence or addition of one or more of other features, whole pieces, steps, or components.

### BRIEF DESCRIPTION OF DRAWINGS

The above and other features of the present invention will be more pronounced through the following detailed description taken in conjunction with the accompanying drawings.

FIG. 1 schematically illustrates a flow diagram of a method 100 for execution of random access at a UE according to an embodiment of the present invention;

FIG. 2 schematically illustrates a flow diagram of a method 200 for execution of random access at a base station according to an embodiment of the present invention;

FIG. 3 schematically illustrates a structural block diagram of a UE 300 according to an embodiment of the present invention;

FIG. 4 schematically illustrates a structural block diagram of a base station 400 according to an embodiment of the present invention;

FIG. 5 schematically illustrates a flow diagram of a method 500 for execution of random access at a UE according to an embodiment of the present invention;

FIG. 6 schematically illustrates a flow diagram of a method 600 for execution of random access at a source base station according to an embodiment of the present invention;

FIG. 7 schematically illustrates a flow diagram of a method 700 for execution of random access at a target base station according to an embodiment of the present invention;

FIG. 8 schematically illustrates a structural block diagram of a UE 800 according to an embodiment of the present invention;

FIG. 9 schematically illustrates a structural block diagram of a source base station 900 according to an embodiment of the present invention; and

FIG. 10 schematically illustrates a structural block diagram of a target base station 1000 according to an embodiment of the present invention.

### DETAILED DESCRIPTION OF EMBODIMENTS

With reference to the accompanying drawings, the above described and other features of the present invention would be more pronounced through the description hereinafter. In the description and accompanying drawings, specific implementation manners of the present invention are disclosed, and some implementation manners that may be implemented based on the principle of the present invention are illustrated. It should be understood that the present invention is not limited to the specific implementation manners described below. On the contrary, the present invention includes all of the modifications, variations, and equivalents falling within the scope defined by the appended claims. In addition, for simplicity, detailed description of the known art not directly related to the present invention is omitted to prevent confusion with respect to the understanding of the present invention.

With reference to the accompanying drawings and specific embodiments, a random access method proposed by the present invention is described in more details hereinafter.

Multiple embodiments according to the present invention are specifically described below by using an LTE mobile communications system and its subsequent evolved version as an exemplary application environment and an NB-IoT is used as an exemplary implementation technical scenario. However, it should be understood that the application environment of the present invention is not limited to the above exemplary application environment; and the present invention may be applicable to more other wireless communications systems, such as the 5G cellular communications system in the future. Moreover, the implementation technical scenario of the present invention is also not limited to NB-IoT; and the present invention may be applicable to other non-NB-IoT devices and systems, such as enhanced Machine Type Communication (MTC) scenarios or the like.

Hereinafter, the description is provided by using an eNB as an example of a base station. However, it should be understood that the base station described in the present invention is not limited thereto and may further comprise a variety of base stations such as a macro base station, a micro base station, or a pico base station.

Information Elements (IEs) mainly involved in the present invention are introduced hereinafter at first.

RACH-ConfigCommon-NB: this information element is used for defining general parameters of random access, including at least one of the following parameters (also referred to as information elements): preambleTransMax-CE for indicating the maximum number of transmissions of a preamble, powerRampingParameters comprising a power ramping step and initial receiving target power of the preamble, and rach-InfoList comprising a set of ra-ResponseWindowSize that indicates a random access response window size and mac-ContentionResolutionTimer that indicates a contention resolution time.

NPRACH-ConfigSIB-NB: this information element is used for defining a configuration of an NB-IoT Physical Random Access Channel (NPRACH), including at least one of the following parameters: nprach-CP-Length for indicating a transmission cycle prefix length of the NPRACH, rsrp-ThresholdsPrachInfoList for indicating that a UE selects an NPRACH resource criterion, and nprach-ParametersList that respectively configures NPRACH parameters for a set of NPRACH resources.

NPRACH-ParametersList: this information element respectively configures NPRACH parameters for a set of NPRACH resources, including at least one of the following parameters: nprach-Periodicity for indicating an NPRACH resource period, nprach-StartTime for indicating a starting position of an NPRACH resource in one period, nprach-SubcarrierOffset for indicating a frequency domain position of an NPRACH resource, nprach-NumSubcarriers for indicating the number of subcarriers contained in one NPRACH resource, nprach-SubcarrierMSG3-RangeStart for calculating a starting subcarrier number of NPRACH subcarriers supporting multi-carrier Msg3 transmission reserved for a UE, and maxNumPreambleAttemptCE for indicating the maximum number of transmissions of a preamble on each PRACH resource, numRepetitionsPerPreambleAttempt for indicating the number of repetitions upon each transmission of an NPRACH on each PRACH resource, npdcch-NumRepetitions-RA for indicating the maximum number of repetitions of an NPDCCH common search space related to an RAR, an Msg3 retransmission, and an Msg4, npdcch-StartSF-CSS-RA for indicating a starting subframe configuration of an NPDCCH common search space related to an RAR, an Msg3 retransmission, and an Msg4, and npdcch-Offset-RA for indicating a partial period offset of a starting subframe of an NPDCCH common search space.

It is noted that in the present invention, RACH-ConfigCommon-NB, NPRACH-ConfigSIB-NB, and NPRACH-ParametersList-NB related to an anchor carrier are respectively represented as RACH-ConfigCommonAnchor-NB, NPRACH-ConfigSIBAnchor-NB, and NPRACH-ParametersListAnchor-NB; and RACH-ConfigCommon-NB, NPRACH-ConfigSIB-NB, and NPRACH-ParametersList-NB related to a non-anchor carrier are respectively represented as: RACH-ConfigCommonNonAnchor-NB, NPRACH-ConfigSIBNonAnchor-NB, and NPRACH-ParametersListNonAnchor-NB.

The random access resource involved in the present invention refers to parameters required to be obtained when a UE performs random access, and comprises but not limited to all or part of parameters contained in the information element RACH-ConfigCommon-NB and/or the information element NPRACH-ConfigSIB-NB and/or the information element NPRACH-ParametersList-NB or the like.

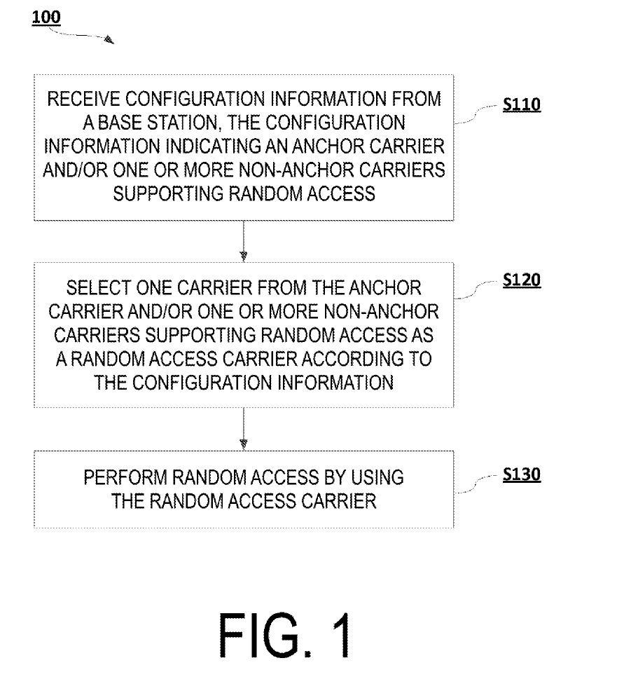

A method for execution of random access at a UE according to an embodiment of the present invention will be described below with reference to FIG. 1. FIG. 1 schematically illustrates a flow diagram of a method 100 for execution of random access at a UE according to an embodiment of the present invention.

As shown in FIG. 1, at step S110, the UE receives configuration information from an eNB. The configuration information indicates an anchor carrier and/or one or more non-anchor carriers supporting random access. The configuration information comprises at least configuration information of one or more non-anchor carriers available for random access. The configuration information can be broadcasted in system information.

For example, the configuration information is received through SystemInformationBlockType2-NB IE defined by the 3GPP standard TS 36.331 and/or further through RadioResourceConfigCommonSIB-NB IE contained in SystemInformationBlockType2-NB. The configuration information can also be sent through RRC dedicated signaling. The RRC dedicated signaling can be an RRC reconfiguration message. For example, the configuration information is received through RRCConnectionReconfiguration-NB IE defined by the TS 36.331 and/or further through RadioResourceConfigDedicated-NB IE contained in RRCConnectionReconfiguration-NB, wherein the RadioResourceConfigDedicated-NB information element is used for establishing or modifying or releasing a radio bearer (RB) and/or modifying a MAC main configuration and modifying a particular physical layer configuration.

It is noted that the method for configuring anchor carrier and/or non-anchor carrier related parameters (the parameters including but not limited to uplink and downlink carrier frequencies and random access resources) involved in the present invention includes but not limited to: configuring the parameters in a broadcast manner (e.g., broadcasting in system information) or in a unicast manner (e.g., sending through RRC dedicated signaling, wherein the RRC dedicated signaling can be an RRC reconfiguration message or the like).

At step S120, the UE selects one carrier from the anchor carrier and/or one or more non-anchor carriers supporting random access as a random access carrier according to the configuration information.

In one implementation, step S120 can comprise: selecting one carrier from the anchor carrier and/or one or more non-anchor carriers supporting random access indicated by the configuration information as a random access carrier in a random selection manner, an equal probability random selection manner, or in accordance with a predefined rule.

In one implementation, if a downlink carrier on which the UE receives a paging message is provided with a corresponding uplink carrier and the uplink carrier (which may be an anchor carrier or a non-anchor carrier) supports random access, then the random access carrier is the uplink carrier, i.e., a carrier on which the UE receives the paging message.

In one implementation, step S120 can comprise: if the downlink carrier on which the UE receives the paging message is not provided with the corresponding uplink carrier or the configured corresponding uplink carrier does not support random access, selecting an anchor carrier supporting random access indicated by the configuration information as the random access carrier, or selecting one carrier from the anchor carrier and/or one or more non-anchor carriers supporting random access indicated by the configuration information as the random access carrier in a random selection manner, an equal probability random selection manner, or in accordance with a predefined rule.

In one implementation, if a Physical Downlink Control Channel (PDCCH) or an upper layer indicates a carrier for the UE to perform random access, the random access carrier is the indicated carrier. For example, if a PDCCH order or an upper layer (e.g., RRC) indicates a carrier for the UE to perform random access, the UE performs random access on the indicated carrier.

In one implementation, the random access carrier is a non-anchor carrier having an RACH-ConfigCommon-NB and/or NPRACH-ConfigSIB-NB information element of an RRC configuration.

In one implementation, if a serving carrier of the UE (e.g., the UE can perform a receiving and/or sending operation of unicast data on the carrier) supports random access (e.g., provided with a random access resource), the random access carrier is the serving carrier, i.e., the UE performs random access on the serving carrier. The serving carrier can be an anchor carrier or a non-anchor carrier.

If the serving carrier of the UE (i.e., the UE can perform a receiving and/or sending operation of unicast data on the carrier) cannot be used as the random access carrier (i.e., provided with a random access resource), the UE can select a carrier available for random access to perform random access. Preferably, the UE performs random access on an anchor carrier (including uplink and downlink carriers). Alternatively, the UE selects a non-anchor carrier as the random access carrier in accordance with a predefined rule. For example, a carrier corresponding to a value obtained by a UE identity mod the number of random access carriers (which can comprise anchor carriers and/or non-anchor carriers) corresponding to an enhanced coverage level n is used as the random access carrier. The UE identity can be an identity for distinguishing between different UEs, such as a C-RNTI or an S-TMSI or an IMSI or the like.

In one implementation, step S120 can comprise: further selecting the random access carrier based on an enhanced coverage level of the UE.

For example, the UE can select a corresponding carrier as the random access carrier based on a measured signal strength (measured RSRP or enhanced coverage level). That is, if the UE considers that its enhanced coverage level is n, the UE selects a random access carrier corresponding to the enhanced coverage level n. If there are multiple random access carriers (which can comprise anchor carriers and/or non-anchor carriers) corresponding to the enhanced coverage level n, the UE can select one carrier in an equal probability random selection manner or in accordance with a set rule. The set rule can comprise: a carrier corresponding to a value obtained by a UE identity mod the number of random access carriers corresponding to an enhanced coverage level n is used as the random access carrier. The UE identity can be an identity for distinguishing between different UEs, such as a C-RNTI or an S-TMSI or an IMSI or the like.

In one implementation, step S120 can comprise: further selecting the random access carrier based on a data size. For example, a size of a potential message is compared with a predetermined threshold; and then the random access carrier is selected according to a comparison result.

In one implementation, the configuration information indicates one or more random access resource configurations for random access.

In one implementation, the configuration information comprises an indication for indicating whether a non-anchor carrier shares the same random access resource configuration with a corresponding anchor carrier.

In one implementation, an RACH-ConfigCommon-NB and/or NPRACH-ConfigSIB-NB configuration of an anchor carrier is different from an RACH-ConfigCommon-NB and/or NPRACH-ConfigSIB-NB configuration of a non-anchor carrier.

In one implementation, NPRACH-ParametersList-NB of an anchor carrier is different from NPRACH-ParametersList-NB of a non-anchor carrier.

In one implementation, one or more non-anchor carriers in the one or more non-anchor carriers share the same random access resource configuration with the anchor carrier.

In one implementation, the random access resource configuration comprises at least one of RACH-ConfigCommon-NB, NPRACH-ConfigSIB-NB, or NPRACH-ParametersList-NB.

In one implementation, the configuration information comprises an indication sign for indicating whether a corresponding anchor carrier or non-anchor carrier supports random access. When a value of the indication sign is set to “True” or “Setup” or “1”, the corresponding anchor carrier or non-anchor carrier supports random access; and when the value of the indication sign is set to “False” or “Release” or “0”, the corresponding non-anchor carrier does not support random access.

In one implementation, the configuration information comprises an indication sign for indicating whether a corresponding non-anchor carrier uses the same random access resource configuration as an anchor carrier. When a value of the indication sign is set to “True” or “Setup” or “1”, the corresponding non-anchor carrier uses the same random access resource configuration as the anchor carrier; and when the value of the indication sign is set to “False” or “Release” or “0” or the indication is absent, a random access resource configuration used by the corresponding non-anchor carrier is different from that used by the anchor carrier.

In one example, the UE randomly selects a carrier to perform random access from anchor carriers and non-anchor carriers that can be used as random access carriers. In another example, if one or more non-anchor carriers available for random access are configured, the UE selects one non-anchor carrier from the non-anchor carriers as the random access carrier. Preferably, the UE randomly selects one non-anchor carrier from the non-anchor carriers as the random access carrier. Alternatively, the UE selects one non-anchor carrier as the random access carrier in accordance with a predefined rule. For example, a carrier corresponding to a value obtained by a UE identity mod the number of random access carriers (which can comprise anchor carriers and/or non-anchor carriers) corresponding to an enhanced coverage level n is used as the random access carrier. The UE identity can be an identity for distinguishing between different UEs, such as a C-RNTI or an S-TMSI or an IMSI or the like.

In yet another example, if only one uplink carrier available for random access is configured, the UE performs random access on the uplink carrier. Preferably, the uplink carrier is an uplink carrier of an anchor carrier. Preferably, the UE uses a downlink carrier of the anchor carrier as a downlink carrier for executing random access. Alternatively, the UE selects one of the configured downlink non-anchor carriers as a downlink carrier for executing random access, for example, in an equal probability random selection manner.

At step S130, the UE performs random access by using the random access carrier.

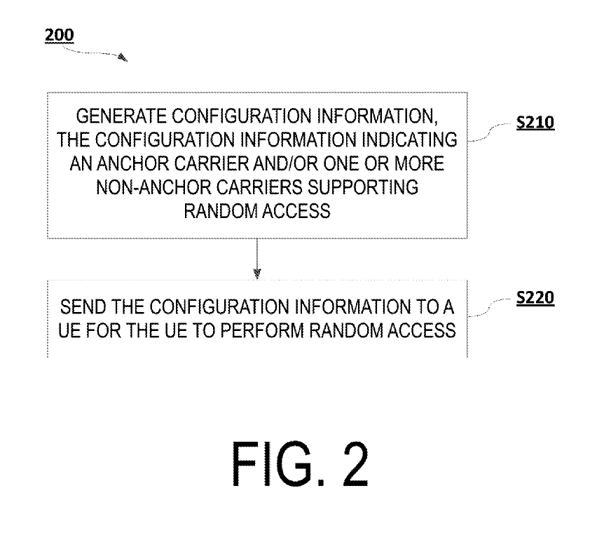

A method for execution of random access at a base station according to an embodiment of the present invention will be described below with reference to FIG. 2. FIG. 2 schematically illustrates a flow diagram of a method 200 for execution of random access at a base station according to an embodiment of the present invention.

As shown in FIG. 2, at step S210, an eNB generates configuration information. The configuration information indicates an anchor carrier and/or one or more non-anchor carriers supporting random access. For example, the configuration information here may be the configuration information received by the UE from the eNB at step S110.

At step S220, the eNB sends the configuration information to a UE for the UE to perform random access.

Methods for configuring one or more non-anchor carriers as random access carriers and configuring a corresponding random access resource are introduced in detail below.

The configuration information of the non-anchor carrier can comprise one or more of the following information elements: RACH-ConfigCommonNonanchor-NB, NPRACH-ConfigSIBNonanchor-NB, NPRACH-ParametersListNonanchor-NB, and dl-CarrierFreq, downlinkBitmapNonAnchor, dl-GapNonAnchor, and inbandCarrierinfo related to a downlink carrier configuration, and UL-CarrierConfigDedicated-NB related to an uplink carrier configuration. The information element dl-CarrierFreq is used for indicating a downlink carrier, which is a PRB that is not used for transmitting an E-UTRA PSS/SSS/PBCH; the information element downlinkBitmapNonAnchor is used for indicating an NB-IoT downlink subframe configuration of a downlink transmission of a non-anchor carrier; the information element DL-GapNonAnchor is used for indicating a downlink transmission gap configuration of a non-anchor carrier; the information element inbandCarrierinfo comprises a configuration of an in-band non-anchor carrier, for example, information elements defined in the 3GPP standard TS 36.331, such as indexToMidPRB, eutra-NumCRS-Ports, eutraControlRegionSize or the like; and the information element UL-CarrierConfigDedicated-NB is used for indicating an uplink carrier. The non-anchor carrier configuration information can be divided into non-anchor carrier common configuration information and non-anchor carrier dedicated configuration information. The non-anchor carrier common configuration information comprises non-anchor carrier configuration information shared by all non-anchor carriers. The non-anchor carrier dedicated configuration information comprises configuration information only applicable to corresponding non-anchor carriers. For example, the non-anchor carrier common configuration information can comprise the RACH-ConfigCommonNonanchor-NB and/or NPRACH-ConfigSIBNonanchor-NB and/or NPRACH-ParametersListNonanchor-NB and/or downlinkBitmapNonAnchor and/or DL-GapNonAnchor information element; and configuration information of other non-anchor carriers not contained in the non-anchor carrier common configuration information can be contained in the non-anchor carrier dedicated configuration information. If the information element dl-CarrierFreq and/or the information element UL-CarrierConfigDedicated-NB is contained in the non-anchor carrier common configuration information, it is indicated that these non-anchor carriers can share uplink carriers and/or downlink carriers. If the dedicated configuration information of each non-anchor carrier does not comprise the information element dl-CarrierFreq and/or the information element UL-CarrierConfigDedicated-NB and the information element is contained in the common configuration information, uplink carriers and/or downlink carriers having a common configuration can be used; and if the dedicated configuration information of each non-anchor carrier does not comprise the information element dl-CarrierFreq and/or the information element UL-CarrierConfigDedicated-NB and the information element is also not contained in the common configuration information, an uplink carrier and/or downlink carrier of an anchor carrier can be used. Alternatively, if the dedicated configuration information of each non-anchor carrier further comprises one carrier indication information element used for indicating whether a corresponding non-anchor carrier uses an uplink carrier and/or downlink carrier in the common configuration information or uses an uplink carrier and/or downlink carrier of an anchor carrier when dedicated configuration information of a certain non-anchor carrier does not comprise the information element dl-CarrierFreq and/or the information element UL-CarrierConfigDedicated-NB. In particular, when a value of the indication information element is set to “true” or “setup” or “1”, the UE considers that a corresponding non-anchor carrier uses an uplink carrier and/or downlink carrier in the common configuration information; when the value of the indication information element is set to “false” or “release” or “0” or the indication sign is absent, the UE considers that a corresponding non-anchor carrier uses an uplink carrier and/or downlink carrier of an anchor carrier; and vice versa.

Alternatively, the non-anchor carrier configuration information further comprises a first indication sign used for indicating whether a corresponding non-anchor carrier can be used as a random access carrier; and the first indication sign can be contained in the non-anchor carrier dedicated configuration information. In particular, when a value of the indication sign is set to “true” or “setup” or “1”, the UE considers that a corresponding non-anchor carrier can be used as a random access carrier (i.e., the UE can perform random access on the carrier); when the value of the indication sign is set to “false” or “release” or “0” or the indication sign is absent, the UE considers that a corresponding non-anchor carrier is not used as a random access carrier; and vice versa.

Alternatively, the non-anchor carrier configuration information further comprises a second indication sign used for indicating whether a corresponding non-anchor carrier uses a random access resource configuration of an anchor carrier or indicating whether a PSS/SSS/NPBCH/SIB-NB has been transmitted on a non-anchor carrier (if a PSS/SSS/NPBCH/SIB-NB has been transmitted on a non-anchor carrier, the non-anchor carrier uses a random access resource configuration of an anchor carrier). In particular, when a value of the indication sign is set to “true” or “setup” or “1”, the UE considers that a corresponding non-anchor carrier uses a random access resource configuration of an anchor carrier; and when the value of the indication sign is set to “false” or “release” or “0” or the indication sign is absent, the UE considers that a corresponding non-anchor carrier does not use a random access resource configuration of an anchor carrier. The second indication sign can be contained in the non-anchor carrier dedicated configuration information.

Alternatively, the non-anchor carrier configuration information further comprises a third indication sign used for indicating a corresponding non-anchor carrier can be used as a random access carrier for a UE at which enhanced coverage level (the number of repetitions). Specifically, the UE compares a measured signal strength (e.g., an RSRP value) with a value of the third indication sign; and if the measured signal strength is greater than or lower than the value of the third indication sign, a corresponding non-anchor carrier can be used as a random access carrier for the UE. The third indication sign can be contained in the non-anchor carrier dedicated configuration information.

Alternatively, the configuration information further comprises a fourth indication sign used for indicating whether an anchor carrier can be used as a random access carrier (i.e., an uplink carrier on which the UE can transmit a preamble and a corresponding downlink carrier on which the UE can receive a downlink message such as a Random Access Response (RAR) or the like). In particular, when a value of the indication sign is set to “true” or “setup” or “1”, the UE considers that an anchor carrier can be used as a random access carrier; when the value of the indication sign is set to “false” or “release” or “0” or the indication sign is absent, the UE considers that an anchor carrier cannot be used as a random access carrier; and vice versa.

Alternatively, the configuration information further comprises a threshold for the UE to select a carrier for executing random access. If random access is triggered by an upper layer (i.e., a CCCH logical channel), the UE compares a size of a CCCH Service Data Unit (SDU) plus a MAC header with the threshold, and selects a carrier for random access according to a comparison result. If random access is not triggered by an upper layer (i.e., a CCCH logical channel), the UE compares a size of a potential message (which can comprise uplink transmission data plus a MAC header plus MAC control elements required to be transmitted) with the threshold, and selects a carrier for random access according to a comparison result. For example, if the size of the CCCH SDU plus the MAC header or the size of the potential message is less than the threshold, the UE performs random access on an anchor carrier; if the size of the CCCH SDU plus the MAC header or the size of the potential message is greater than the threshold, the UE performs random access on a non-anchor carrier (e.g., if multiple non-anchor carriers can be used for random access, one of the non-anchor carriers can be randomly selected); and vice versa.

Alternatively, the configuration information comprises configuration information of multiple sets of non-anchor carriers; and the multiple sets of non-anchor carriers are respectively used by UEs at different coverage levels (the number of repetitions) to perform random access. The multiple sets of non-anchor carriers can also be respectively provided with different random access resources; and the multiple sets of non-anchor carriers can share part of the random access resource configuration. For example, the multiple sets of non-anchor carriers share RACH-ConfigCommon-NB and/or NPRACH-ConfigSIB-NB and/or NPRACH-ParametersList-NB.

Alternatively, the configuration information further comprises an anchor carrier related random access resource configuration and a non-anchor carrier related random access resource configuration. Preferably, the anchor carrier and the non-anchor carrier can share part of parameters of a random access resource configuration. That is, the random access resource configurations of the anchor carrier and the non-anchor carrier comprise a random access resource common configuration portion and a random access resource dedicated configuration portion. The random access resource common configuration portion comprises random access resource configuration parameters applicable to the anchor carrier and the non-anchor carrier. Random access resource configuration parameters contained in the random access resource dedicated configuration portion are only applicable to the anchor carrier or the non-anchor carrier.

Specifically, the eNB configures common RACH-ConfigCommon-NB for an anchor carrier and all non-anchor carriers, and configures NPRACH-ConfigSIBAnchor-NB and/or NPRACH-ParametersListAnchor-NB for the anchor carrier; and the eNB configures NPRACH-C onfigSIBNonAnchor-NB and/or NPRACH-ParametersListNonAnchor-NB for the non-anchor carriers.

Alternatively, the eNB configures common NPRACH-ConfigSIB-NB for an anchor carrier and all non-anchor carriers, and configures RACH-ConfigCommonAnchor-NB and/or NPRACH-ParametersListAnchor-NB for the anchor carrier; and the eNB configures RACH-ConfigCommonNonAnchor-NB and/or NPRACH-ParametersListNonAnchor-NB for the non-anchor carriers.

Alternatively, the eNB configures common NPRACH-ParametersList-NB for an anchor carrier and all non-anchor carriers, and configures RACH-ConfigCommonAnchor-NB and/or NPRACH-ConfigSIBAnchor-NB for the anchor carrier; and the eNB configures RACH-ConfigCommonNonAnchor-NB and/or NPRACH-ConfigSIBNonAnchor-NB for the non-anchor carriers.

Alternatively, the eNB configures common RACH-ConfigCommon-NB and NPRACH-ConfigSIB-NB for an anchor carrier and all non-anchor carriers, and configures NPRACH-ParametersListAnchor-NB for the anchor carrier; and the eNB configures NPRACH-ParametersListNonAnchor-NB for the non-anchor carriers.

Alternatively, the eNB configures common NPRACH-ParametersList-NB and RACH-ConfigCommon-NB for an anchor carrier and all non-anchor carriers, and configures NPRACH-ConfigSIBAnchor-NB for the anchor carrier; and the eNB configures NPRACH-ConfigSIBNonAnchor-NB for the non-anchor carriers.

Alternatively, the eNB configures common NPRACH-ParametersList-NB and NPRACH-ConfigSIB-NB for an anchor carrier and all non-anchor carriers, and configures RACH-ConfigCommonAnchor-NB for the anchor carrier; and the eNB configures RACH-ConfigCommonNonAnchor-NB for the non-anchor carriers.

Alternatively, the eNB configures common RACH-ConfigCommon-NB, NPRACH-ConfigSIB-NB, and NPRACH-ParametersList-NB for an anchor carrier and all non-anchor carriers. In this case, the anchor carrier and all of the non-anchor carriers use the same random access resource configuration.

Alternatively, the eNB configures common RACH-ConfigCommonNonAnchor-NB and/or NPRACH-ConfigSIBNonAnchor-NB and/or NPRACH-P arametersListNonAnchor-NB for all non-anchor carriers.

Alternatively, the eNB configures RACH-ConfigCommonNonAnchor-NB and/or NPRACH-ConfigSIBNonAnchor-NB and/or NPRACH-ParametersListNonAnchor-NB for each non-anchor carrier. Optionally, if a certain non-anchor carrier available for random access is not provided with part or all of the random access resources (which can comprise RACH-ConfigCommonNonAnchor-NB and/or NPRACH-ConfigSIBNonAnchor-NB and/or NPRACH-ParametersListNonAnchor-NB), it is considered that the random access resource configuration of a corresponding non-anchor carrier is identical with that of an anchor carrier.

Alternatively, the eNB can place configuration information of a non-anchor carrier in one or more separate information elements, and place a configuration of one or more random access resources in the other one or more separate information elements; and then the eNB indicates in each of configured random access resources non-anchor carriers to which a corresponding random access resource is applied. For example, assuming that 5 non-anchor carriers are configured and configuration information of the non-anchor carriers comprises part or all of the following information elements: dl-CarrierFreq, downlinkBitmapNonAnchor, dl-GapNonAnchor, and inbandCarrierinfo related to a downlink carrier configuration, and UL-CarrierConfigDedicated-NB related to an uplink carrier configuration; and 3 random access resources are configured and the random access resources comprise part or all of the following information elements: RACH-ConfigCommonNonanchor-NB, NPRACH-ConfigSIBNonanchor-NB, NPRACH-ParametersListNonanchor-NB, and the like. The eNB indicates in the random access resources non-anchor carriers to which the random access resources are applied. In particular, configured non-anchor carriers can be indicated in the form of a bitmap; or the configured non-anchor carriers are numbered and then the numbers thereof are indicated.

It is noted that if random access resources (which can comprise RACH-ConfigCommonNonAnchor-NB and/or NPRACH-ConfigSIBNonAnchor-NB and/or NPRACH-ParametersListNonAnchor-NB) are not contained in configuration information respectively corresponding to anchor carriers and non-anchor carriers but present as common information in the form of a list, it is indicated respective random access resources of the anchor carriers and the non-anchor carriers respectively correspond to which random access resources in the list. Specifically, assuming that the list comprise two RACH-ConfigCommonNonAnchor-NB and/or two NPRACH-ConfigSIBNonAnchor-NB and/or two NPRACH-ParametersListNonAnchor-NB, the first RACH-ConfigCommonNonAnchor-NB and/or NPRACH-ConfigSIBNonAnchor-NB and/or NPRACH-ParametersListNonAnchor-NB in the list can be specified as a random access resource configuration of an anchor carrier; the second RACH-ConfigCommonNonAnchor-NB and/or NPRACH-ConfigSIBNonAnchor-NB and/or NPRACH-ParametersListNonAnchor-NB in the list can be specified as a random access resource configuration of a non-anchor carrier; and vice versa.

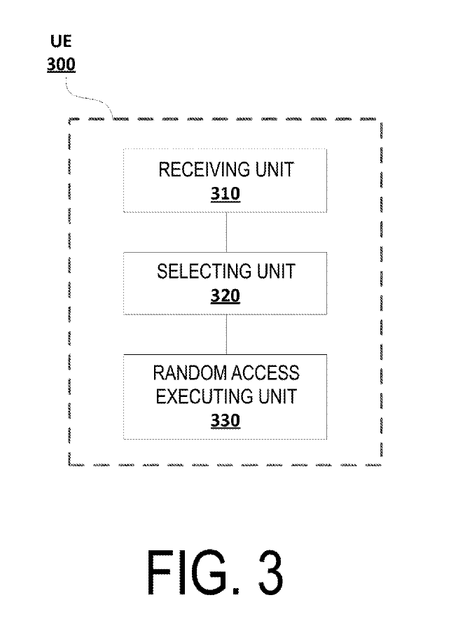

A UE according to an embodiment of the present invention will be described below with reference to FIG. 3. FIG. 3 schematically illustrates a structural block diagram of a UE 300 according to an embodiment of the present invention. The UE 300 can perform the method for random access according to the embodiment of the present invention, for example, the method 100 described in detail previously as shown in FIG. 1.

As shown in FIG. 3, the UE 300 comprises a receiving unit 310, a selecting unit 320, and a random access executing unit 330. Those skilled in the art should understand that only the receiving unit 310, the selecting unit 320, and the random access executing unit 330 related to the present invention are shown in the UE 300 of FIG. 3 to avoid confusion of the present invention. However, those skilled in the art should understand that although not shown in FIG. 3, the UE according to the embodiment of the present invention further comprises other basic units that form the UE.

The receiving unit 310 is used for receiving configuration information from a base station, the configuration information indicating an anchor carrier and/or one or more non-anchor carriers supporting random access.

The selecting unit 320 is used for selecting one carrier from the anchor carrier and/or one or more non-anchor carriers supporting random access as a random access carrier according to the configuration information.

The random access executing unit 330 is used for executing random access by using the random access carrier.

In one implementation, the selecting unit 320 is further used for: selecting one carrier from the anchor carrier and/or one or more non-anchor carriers supporting random access indicated by the configuration information as a random access carrier in a random selection manner, an equal probability random selection manner, or in accordance with a predefined rule.

In one implementation, if a downlink carrier on which the UE receives a paging message is provided with a corresponding uplink carrier and the uplink carrier supports random access, then the random access carrier is the uplink carrier.

In one implementation, the selecting unit 320 is further used for: if the downlink carrier on which the UE receives the paging message is not provided with the corresponding uplink carrier or the configured corresponding uplink carrier does not support random access, selecting an anchor carrier supporting random access indicated by the configuration information as the random access carrier, or selecting one carrier from the anchor carrier and/or one or more non-anchor carriers supporting random access indicated by the configuration information as the random access carrier in a random selection manner, an equal probability random selection manner, or in accordance with a predefined rule.

In one implementation, if a PDCCH or an upper layer specifies a carrier for the UE to perform random access, the random access carrier is the specified carrier.

In one implementation, the random access carrier is a non-anchor carrier having an RACH-ConfigCommon-NB and/or NPRACH-ConfigSIB-NB information element of an RRC configuration.

In one implementation, if a serving carrier of the UE supports random access, then the random access carrier is the serving carrier.

In one implementation, the selecting unit 320 is further used for: further selecting the random access carrier based on an enhanced coverage level of the UE.

In one implementation, the selecting unit 320 is further used for: further selecting the random access carrier based on a data size.

In one implementation, the selecting the random access carrier based on a data size comprises: comparing a size of a potential message with a predetermined threshold; and then selecting the random access carrier according to a comparison result.

In one implementation, the configuration information indicates one or more random access resource configurations for random access.

In one implementation, the configuration information comprises an indication for indicating whether a non-anchor carrier shares the same random access resource configuration with a corresponding anchor carrier.

In one implementation, an RACH-ConfigCommon-NB and/or NPRACH-ConfigSIB-NB configuration of an anchor carrier is different from an RACH-ConfigCommon-NB and/or NPRACH-ConfigSIB-NB configuration of a non-anchor carrier.

In one implementation, NPRACH-ParametersList-NB of an anchor carrier is different from NPRACH-ParametersList-NB of a non-anchor carrier.

In one implementation, one or more non-anchor carriers in the one or more non-anchor carriers share the same random access resources with the anchor carrier.

In one implementation, the random access resource configuration comprises at least one of RACH-ConfigCommon-NB, NPRACH-ConfigSIB-NB, or NPRACH-ParametersList-NB.

In one implementation, the configuration information comprises an indication sign for indicating whether a corresponding anchor carrier or non-anchor carrier supports random access. When a value of the indication sign is set to “True” or “Setup” or “1”, the corresponding anchor carrier or non-anchor carrier supports random access; and when the value of the indication sign is set to “False” or “Release” or “0”, the corresponding non-anchor carrier does not support random access.

In one implementation, the configuration information comprises an indication sign for indicating whether a corresponding non-anchor carrier uses the same random access resource configuration as an anchor carrier. When a value of the indication sign is set to “True” or “Setup” or “1”, the corresponding non-anchor carrier uses the same random access resource configuration as the anchor carrier; and when the value of the indication sign is set to “False” or “Release” or “0” or the indication is absent, a random access resource configuration used by the corresponding non-anchor carrier is different from that used by the anchor carrier.

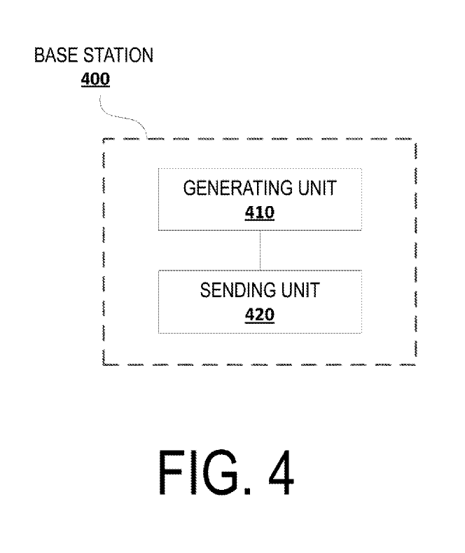

A base station according to an embodiment of the present invention will be described below with reference to FIG. 4. FIG. 4 schematically illustrates a structural block diagram of a base station 400 according to an embodiment of the present invention. The base station 400 can perform the method for random access according to the embodiment of the present invention, for example, the method 200 described in detail previously as shown in FIG. 2.

As shown in FIG. 4, the base station 400 comprises a generating unit 410 and a sending unit 420. Those skilled in the art should understand that only the generating unit 410 and the sending unit 420 related to the present invention are shown in the base station 400 of FIG. 4 to avoid confusion of the present invention. However, those skilled in the art should understand that although not shown in FIG. 4, the base station according to the embodiment of the present invention further comprises other basic units that form the base station.

The generating unit 410 is used for generating configuration information, the configuration information indicating an anchor carrier and/or one or more non-anchor carriers supporting random access.

The sending unit 420 is used for sending the configuration information to a UE for the UE to perform random access.

In one implementation, the sending unit 420 is further used for: broadcasting the configuration information in system information; or sending the configuration information through RRC dedicated signaling.

A random access method in a handover scenario is provided below, i.e., a procedure of a UE performing random access to a target base station during a handover procedure from a source base station to the target base station. A method for determining whether an anchor carrier or a non-anchor carrier is a carrier supporting random access and a selection method by which a UE selects one non-anchor carrier for random access from one or more non-anchor carriers supporting random access involved in the following embodiments include but not limited to those described previously in the present invention, and are not repeatedly described in the following embodiments.

In the present invention, a carrier can also be expressed as a cell or a PRB.

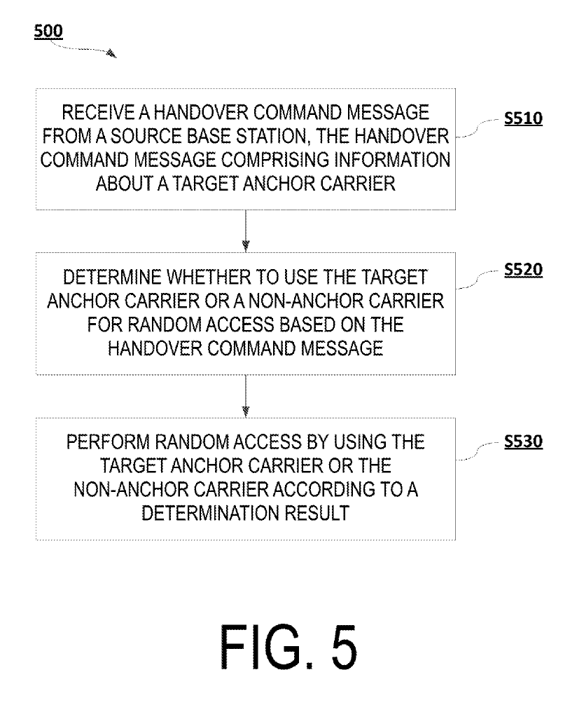

A method for execution of random access at a UE according to an embodiment of the present invention will be described below with reference to FIG. 5. FIG. 5 schematically illustrates a flow diagram of a method 500 for execution of random access at a UE according to an embodiment of the present invention.

As shown in FIG. 5, at step S510, the UE receives a handover command message from an eNB. The handover command message comprises information about a target anchor carrier, i.e., information for indicating a target carrier or a target cell for this handover. In this step, the handover command message is used for instructing the UE to perform a handover operation. For example, the handover command message can be an RRC connection reconfiguration message comprising a mobility control information (mobilitycontrolinfo) information element. Optionally, the handover command message can also comprise non-anchor carrier configuration information about a target non-anchor carrier for configuring a non-anchor carrier (also referred to as a target non-anchor carrier) used by the UE during or after this handover procedure.

This step may also be expressed as: when the RRC connection reconfiguration message comprises the mobility control information information element, or optionally, further comprises the fact that the UE can follow a configuration in the message, or optionally, further comprises the fact that the UE is an NB-IoT UE.

At step S520, the UE determines whether to use the target anchor carrier or a non-anchor carrier for random access based on the handover command message.

Optionally, prior to S520, the UE begins to perform downlink synchronization to synchronize to a target anchor carrier and/or receives system information on the target anchor carrier. The system information here comprises related information required to be obtained for performing random access on a target non-anchor carrier, for example, non-anchor carrier configuration information, including an RACH configuration and a PRACH configuration corresponding to a non-anchor carrier. For example, the non-anchor carrier configuration information can be a non-anchor carrier frequency or index number, indication information for indicating whether a non-anchor carrier is a random access carrier, downlinkBitmapNonAnchor, dl-GapNonAnchor, and inbandCarrierinfo configurations corresponding to a non-anchor carrier or the like. The specific details are given in the foregoing random access configuration section of the present invention. Alternatively, the UE can obtain the related information required to be obtained for executing random access on a target non-anchor carrier from an eNB by means of dedicated signaling, for example, a handover command.

In one implementation, step S520 can comprise: if the handover command message does not comprise non-anchor carrier configuration information about a target non-anchor carrier, determining to use the target anchor carrier for random access.

For example, if the handover command message does not comprise the non-anchor carrier configuration information, the UE can perform one or more of the following operations:
If the handover command message comprises a dedicated random access channel configuration (RACH-ConfigDedicated), the UE considers that the dedicated random access channel configuration is for a target anchor carrier.
The UE performs random access on the target anchor carrier.

In one implementation, step S520 can comprise: if the handover command message comprises the non-anchor carrier configuration information about the target non-anchor carrier and the handover command message or target cell system information does not comprise random access configuration information corresponding to the target non-anchor carrier, determining to use the target anchor carrier for random access.

For example, if the handover command message comprises the non-anchor carrier configuration information and the handover command message or the target cell system information does not comprise the random access configuration information corresponding to the target non-anchor carrier (e.g., the random access configuration information can comprise nprach-config and/or rach-configcommon, as previously described in the present invention), the UE performs one or more of the following operations:
If the handover command message comprises a dedicated random access channel configuration (RACH-ConfigDedicated), the UE considers that the dedicated random access channel configuration is for a target anchor carrier.
The UE performs random access on the target anchor carrier.

In one implementation, step S520 can comprise: if the handover command message comprises the non-anchor carrier configuration information about the target non-anchor carrier and the target non-anchor carrier indicated by the non-anchor carrier configuration information does not support random access, determining to use the target anchor carrier for random access.

For example, if the handover command message comprises the non-anchor carrier configuration information and the target non-anchor carrier indicated by the non-anchor carrier configuration information is not a random access carrier, the UE performs one or more of the following operations:
If the handover command message comprises a dedicated random access channel configuration (RACH-ConfigDedicated), the UE considers that the dedicated random access channel configuration is for the anchor carrier.
The UE performs random access on the target anchor carrier.

In this implementation, the anchor carrier refers to the target anchor carrier; that the non-anchor carrier is not a random access carrier can be acquired from indication information received from the eNB, can also be acquired according to the fact that a random access carrier list received from the eNB does not comprise the non-anchor carrier, and can also be acquired according to the fact that the non-anchor carrier list received from the eNB comprises the non-anchor carrier but does not comprise an RA carrier indication (e.g., the foregoing first indication sign) corresponding to the non-anchor carrier. However, the present invention is not limited to the above-described methods.

In one implementation, step S520 can comprise: if the handover command message comprises the non-anchor carrier configuration information about the target non-anchor carrier and the handover command message or the target cell system information comprises the random access configuration information corresponding to the target non-anchor carrier, determining to use the target non-anchor carrier for random access.

For example, if the handover command message comprises the non-anchor carrier configuration information and the handover command message or the target cell system information comprises the random access configuration information corresponding to the target non-anchor carrier (e.g., the random access configuration information can comprise nprach-config and/or rach-configcommon), the UE performs one or more of the following operations:
If the handover command message comprises a dedicated random access channel configuration (RACH-ConfigDedicated), the UE considers that the dedicated random access channel configuration is for the non-anchor carrier.
The UE performs random access on the target non-anchor carrier.

In one implementation, step S520 can comprise: if the handover command message comprises the non-anchor carrier configuration information about the target non-anchor carrier, determining to use the target non-anchor carrier for random access.

For example, if the handover command message comprises the non-anchor carrier configuration information, the UE performs one or more of the following operations:
If the handover command message comprises a dedicated random access channel configuration (RACH-ConfigDedicated), the UE considers that the dedicated random access channel configuration is for the target non-anchor carrier.
The UE performs random access on the target non-anchor carrier. In one implementation, step S520 can comprise: if the handover command message comprises the non-anchor carrier configuration information about the target non-anchor carrier and the target non-anchor carrier indicated by the non-anchor carrier configuration information supports random access, determining to use the target non-anchor carrier for random access.

For example, if the handover command message comprises the non-anchor carrier configuration information and the target non-anchor carrier indicated by the non-anchor carrier configuration information supports random access, the UE performs one or more of the following operations:
If the handover command message comprises a dedicated random access channel configuration (RACH-ConfigDedicated), the UE considers that the dedicated random access channel configuration is for the non-anchor carrier.
The UE performs random access on the target non-anchor carrier.

That the non-anchor carrier is a random access carrier can be acquired from indication information received from the eNB, can also be acquired according to the fact that the random access carrier list received from the eNB comprises the non-anchor carrier, and can also be acquired according to the fact that the non-anchor carrier list received from the eNB comprises the non-anchor carrier and comprises the RA carrier indication (e.g., the foregoing first indication sign) corresponding to the non-anchor carrier. However, the present invention is not limited to the above-described methods. In the above-described implementations, the non-anchor carrier refers to a target non-anchor carrier indicated in the handover command.

In one implementation, step S520 can comprise: if the handover command message comprises the non-anchor carrier configuration information about the target non-anchor carrier, the handover command message or the target cell system information indicates that the target anchor carrier does not support random access, and the non-anchor carrier configuration information indicates that the target non-anchor carrier does not support random access, selecting one non-anchor carrier for random access from one or more carriers supporting random access.

For example, if the handover command message comprises the non-anchor carrier configuration information and the handover command message or the target cell system information comprises an indication (e.g., the foregoing fourth indication sign) for indicating that the target anchor carrier does not support random access, the UE performs one or more of the following operations:
If the target non-anchor carrier supports random access, then
   If the handover command message comprises a dedicated random access channel configuration (RACH-ConfigDedicated), the UE considers that the dedicated random access channel configuration is for the target non-anchor carrier.
   The UE performs random access on the target non-anchor carrier.
If the target non-anchor carrier does not support random access, then:
   The UE selects one non-anchor carrier from one or more carriers supporting random access as a random access carrier (for example, the non-anchor carrier can be selected by using the method 100 in FIG. 1).
   If the handover command message comprises a dedicated random access channel configuration

(RACH-ConfigDedicated), the UE considers that the dedicated random access channel configuration is for the selected non-anchor carrier.
The UE performs random access on the selected non-anchor carrier.

In one implementation, step S520 can comprise: if the handover command message does not comprise the non-anchor carrier configuration information about the target non-anchor carrier and/or the handover command message or the target cell system information indicates that the target anchor carrier does not support random access, selecting one non-anchor carrier for random access from one or more carriers supporting random access.

For example, if the handover command message does not comprise the non-anchor carrier configuration information and/or the handover command message or the target cell system information indicates that the target anchor carrier does not support random access, the UE performs one or more of the following operations:
The UE selects one non-anchor carrier from one or more carriers supporting random access as a random access carrier (for example, the non-anchor carrier can be selected by using the method 100 in FIG. 1).
If the handover command message comprises a dedicated random access channel configuration (RACH-ConfigDedicated), the UE considers that the dedicated random access channel configuration is for the selected non-anchor carrier.
The UE performs random access on the selected non-anchor carrier.

In one implementation, step S520 can comprise: if the handover command message comprises the non-anchor carrier configuration information about the target non-anchor carrier and the handover command message or the target cell system information does not comprise the random access configuration information corresponding to the target non-anchor carrier, selecting one non-anchor carrier for random access from one or more carriers supporting random access.

For example, if the handover command message comprises the non-anchor carrier configuration information and the handover command message or the target cell system information does not comprise the random access configuration information corresponding to the target non-anchor carrier (e.g., the random access configuration information comprises nprach-config and/or rach-configcommon or the like), the UE performs one or more of the following operations:
The UE selects one non-anchor carrier from one or more carriers supporting random access as a random access carrier (for example, the non-anchor carrier can be selected by using the method 100 in FIG. 1).
If the handover command message comprises a dedicated random access channel configuration (RACH-ConfigDedicated), the UE considers that the dedicated random access channel configuration is for the selected non-anchor carrier.
The UE performs random access on the selected non-anchor carrier.

In one implementation, step S520 can comprise: if the handover command message comprises the non-anchor carrier configuration information about the target non-anchor carrier and the target non-anchor carrier does not support random access, selecting one non-anchor carrier for random access from one or more carriers supporting random access.

For example, if the handover command message comprises the non-anchor carrier configuration information and the target non-anchor carrier does not support random access, the UE performs one or more of the following operations:
The UE selects one non-anchor carrier from one or more carriers supporting random access as a random access carrier (for example, the non-anchor carrier can be selected by using the method 100 in FIG. 1).
If the handover command message comprises a dedicated random access channel configuration (RACH-ConfigDedicated), the UE considers that the dedicated random access channel configuration is for to the selected non-anchor carrier.
The UE performs random access on the selected non-anchor carrier.

At step S530, the UE performs random access by using the target anchor carrier or the non-anchor carrier according to a determination result.

In the above embodiments, a carrier for executing random access (process) actually can be considered as a carrier pair comprising a downlink carrier and a corresponding uplink carrier. It thus can be considered that the execution of random access on a carrier as described in the present invention generally comprises: sending a preamble and/or sending an MSG3 on an uplink carrier of a carrier pair; and receiving an RAR and/or an MSG4 on a corresponding downlink carrier of the carrier pair.

In one implementation, if the handover command message comprises RACH-ConfigDedicated configuration information, then the RACH-ConfigDedicated configuration information is valid for a determined target anchor carrier or non-anchor carrier. In this case, step S530 can comprise: sending a preamble and/or an MSG3 message to a target base station on an uplink carrier associated with the determined target anchor carrier or non-anchor carrier; and receiving an RAR and/or an MSG4 message from the target base station on a downlink carrier associated with the determined target anchor carrier or non-anchor carrier.

In one implementation, the non-anchor carrier configuration information is contained in a radioresource-configdedicated information element or a physicalconfig-dedicated information element of the handover command message.

In one implementation, the handover command message is an RRC connection reconfiguration message comprising mobility control information.

Based on the foregoing implementations, optionally, the present invention can further comprise the following UE behaviors.

UE behavior 1: after an MSG3 is sent, if the UE is an NB-IoT UE and is provided with one non-anchor carrier, it is considered that UL grant or DL assignment contained in a received PDCCH transmission on an anchor carrier is valid for the non-anchor carrier. Optionally, prior to this, the present invention further comprises the UE sending a preamble on an anchor carrier or an RA occurring on an anchor carrier. Optionally, prior to this, the present invention further comprises triggering this random access process by means of handover (e.g., an RRC message).

UE behavior 2: the UE is an NB-IoT UE and is provided with one non-anchor carrier; if a random access preamble is sent on an anchor carrier, the UE considers that UL grant contained in an RAR is valid for the non-anchor carrier.

UE behavior 3: in regard to an NB-IoT UE, if a handover command message (i.e., an RRC connection reconfiguration message comprising a mobility control information information element) comprises a non-anchor carrier configuration (carrierConfigDedicated), after the last transmission block carrying a subsequent RRC response message corresponding to the current RRC process is confirmed by a MAC layer, the UE immediately uses the new carrier. This UE behavior is directed to a case in which the UE is provided with a non-anchor carrier in a handover command and a random access process during handover is performed on a target anchor carrier.

This UE behavior can be directed to the following case: the UE is provided with a non-anchor carrier in a handover command message and a random access process during handover is performed on a target anchor carrier.

UE behavior 4: the UE is an NB-IoT UE and is provided with one non-anchor carrier; in regard to non-contention-based random access, if a random access preamble is sent on another non-anchor carrier supporting random access which is different from a configured non-anchor carrier, the UE considers that UL grant contained in a Random Access Response (RAR) is valid for the configured non-anchor carrier.

UE behavior 5: the UE is an NB-IoT UE and is provided with one non-anchor carrier; in regard to contention-based random access, if a random access preamble is sent on another non-anchor carrier supporting random access and different from the configured non-anchor carrier, the UE considers that UL grant or DL assignment contained in a PDCCH transmission received on a non-anchor carrier on which a preamble is sent or random access is performd is valid for the non-anchor carrier.

The UE behaviors 4 and 5 are directed to a case in which the UE is provided with a non-anchor carrier but the configured non-anchor carrier does not support random access, and a random access process occurs on another non-anchor carrier supporting random access.

In order to support random access on a non-anchor carrier, the present invention also proposes the following embodiments.

In one embodiment, all steps of a random access process of a UE are performed on the same carrier (which refers to a carrier pair, i.e., comprising an uplink carrier and a downlink carrier). In particular, a carrier (pair) on which subsequent steps of the random access process are performed is the same carrier (pair) on which a preamble is sent. In this case, in a random access process performed on a non-anchor carrier, the UE considers that UL grant contained in an RAR is valid for the non-anchor carrier; and the UE considers that UL grant or DL assignment contained in a PDCCH transmission received after an MSG3 transmission is valid for the non-anchor carrier.

In addition, in order to enable the UE to properly access a target anchor carrier or a target non-anchor carrier after handover, the present invention further provides a non-anchor carrier configuration information processing method performd on a UE side in a handover process.

In one embodiment, when an RRC connection reconfiguration message comprises the mobility control information (mobilitycontrolinfo) information element (optionally, further comprises the fact that the UE can follow a configuration in the message; or optionally, further comprises the fact that the UE is an NB-IoT UE), if the UE is provided with a non-anchor carrier, the UE will release its non-anchor carrier related configuration information.

The non-anchor carrier related configuration information is as described previously in the present invention. Preferably, the non-anchor carrier related configuration information can refer to CarrierConfigDedicated-NB.

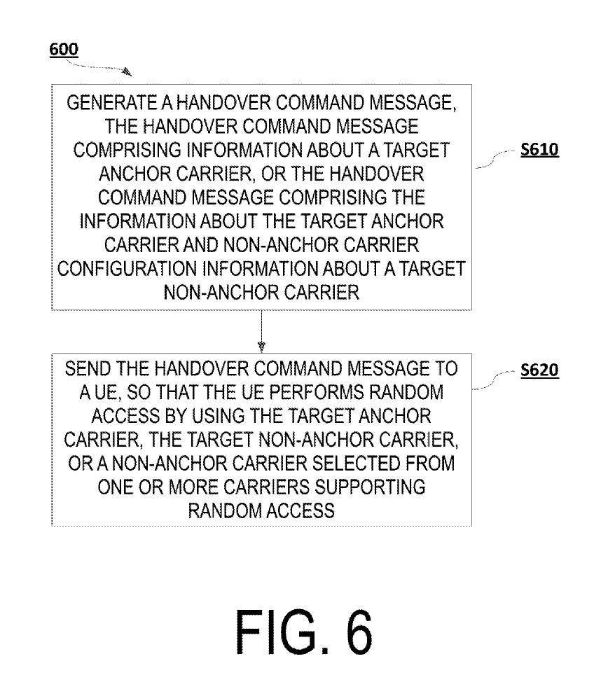

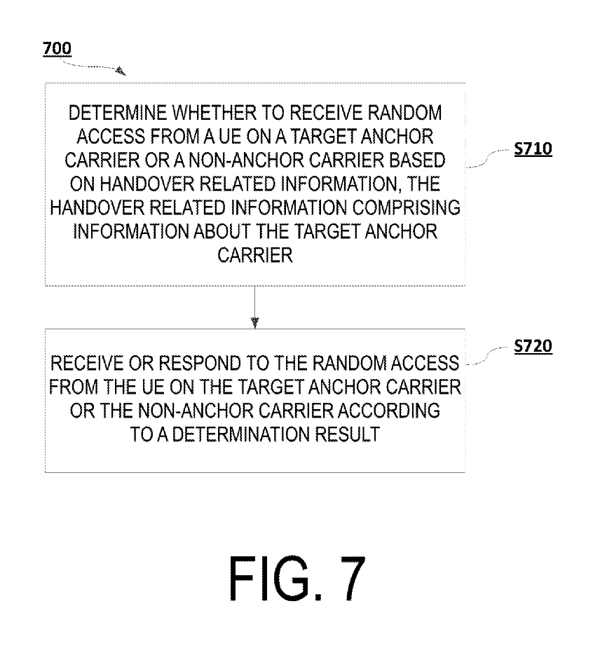

A method for execution of random access at a base station according to an embodiment of the present invention will be described below with reference to FIGS. 6 and 7. FIG. 6 schematically illustrates a flow diagram of a method 600 for execution of random access at a source base station according to an embodiment of the present invention. FIG. 7 schematically illustrates a flow diagram of a method 700 for execution of random access at a target base station according to an embodiment of the present invention.

As shown in FIG. 6, at step S610, a source eNB generates a handover command message. The handover command message comprises information about a target anchor carrier (i.e., information for indicating a target carrier or a target cell for this handover) or the handover command message comprises the information about the target anchor carrier and non-anchor carrier configuration information about a target non-anchor carrier (i.e., information for configuring a non-anchor carrier, also referred to as a target non-anchor carrier, used by the UE during or after this handover process).

At step S620, the source eNB sends the handover command message to a UE, so that the UE performs random access by using the target anchor carrier, the target non-anchor carrier, or a non-anchor carrier selected from one or more carriers supporting random access. The handover command message is used for instructing the UE to perform a handover operation. For example, the handover command message can be an RRC connection reconfiguration message comprising a mobility control information (mobilitycontrolinfo) information element.

In one implementation, the non-anchor carrier configuration information is contained in a radioresource-configdedicated information element or a physicalconfig-dedicated information element of the handover command message.

As shown in FIG. 7, at step S710, the source eNB determines whether to receive random access from a UE on a target anchor carrier or a non-anchor carrier based on handover related information. The handover related information comprises information about the target anchor carrier.

Optionally, at step S710, a target eNB can send to the UE the related information required to be obtained for executing random access on a target non-anchor carrier by means of dedicated signaling, for example, a handover command. As described previously in the present invention, the related information required to be obtained for executing random access on a target non-anchor carrier can be, for example, non-anchor carrier configuration information, or an RACH configuration and a PRACH configuration corresponding to a non-anchor carrier. The non-anchor carrier configuration information is, for example, a non-anchor carrier frequency or index number, indication information for indicating whether a non-anchor carrier is a random access carrier, downlinkBitmapNonAnchor, dl-GapNonAnchor, and inbandCarrierinfo configurations corresponding to a non-anchor carrier or the like.

In one implementation, step S710 can comprise: if the handover related information does not comprise non-anchor carrier configuration information about a target non-anchor carrier, determining to receive or respond to the random access on the target anchor carrier.

In one implementation, step S710 can comprise: if the handover command message comprises the non-anchor carrier configuration information about the target non-anchor carrier and the handover related information or target cell system information does not comprise random access configuration information corresponding to the target non-anchor carrier (e.g., the random access configuration information can comprise nprach-config and/or rach-configcommon), determining to receive or respond to the random access on the target anchor carrier.

In one implementation, step S710 can comprise: if the handover related information comprises the non-anchor carrier configuration information about the target non-anchor carrier and the target non-anchor carrier indicated by the non-anchor carrier configuration information does not support random access, determining to receive or respond to the random access on the target anchor carrier.

In one implementation, step S710 can comprise: if the handover related information comprises the non-anchor carrier configuration information about the target non-anchor carrier and the handover related information or the target cell system information comprises the random access configuration information corresponding to the target non-anchor carrier (e.g., the random access configuration information can comprise nprach-config and/or rach-configcommon), determining to receive or respond to the random access on the target non-anchor carrier.

In one implementation, step S710 can comprise: if the handover command message comprises the non-anchor carrier configuration information about the target non-anchor carrier and the target non-anchor carrier indicated by the non-anchor carrier configuration information supports random access, determining to receive or respond to the random access on the target non-anchor carrier.

In one implementation, step S710 can comprise: if the handover command message comprises the non-anchor carrier configuration information about the target non-anchor carrier, determining to receive or respond to the random access on the target non-anchor carrier.

In one implementation, step S710 can comprise: if the handover related information comprises the non-anchor carrier configuration information about the target non-anchor carrier, the handover related information or the target cell system information indicates that the target anchor carrier does not support random access, and the non-anchor carrier configuration information indicates that the target non-anchor carrier does not support random access, receiving or responding to the random access on one non-anchor carrier supporting random access.

For example, if the handover related information comprises the non-anchor carrier configuration information and the handover related information or the target cell system information indicates that the target anchor carrier does not support random access (e.g., indicated by the foregoing fourth indication sign), the target eNB performs the following operations:
If the target non-anchor carrier supports random access, the target eNB receives or responds to the random access on the target non-anchor carrier; and
If the target non-anchor carrier does not support random access, the target eNB receives or responds to the random access on one non-anchor carrier supporting random access.

In one implementation, step S710 can comprise: if the handover related information does not comprise the non-anchor carrier configuration information about the target non-anchor carrier and/or the handover command message or the target cell system information indicates that the target anchor carrier does not support random access, receiving or responding to the random access on one non-anchor carrier supporting random access.

In one implementation, step S710 can comprise: if the handover related information comprises the non-anchor carrier configuration information about the target non-anchor carrier and the handover related information or the target cell system information does not comprise the random access configuration information corresponding to the target non-anchor carrier (e.g., the random access configuration information can comprise nprach-config and/or rach-configcommon), receiving or responding to the random access on one non-anchor carrier supporting random access.

In one implementation, step S710 can comprise: if the handover command message comprises the non-anchor carrier configuration information about the target non-anchor carrier and the target non-anchor carrier does not support random access, receiving or responding to the random access on one non-anchor carrier supporting random access.

At step S720, the target eNB receives or responds to the random access from the UE on the target anchor carrier or the non-anchor carrier according to a determination result.

In one implementation, if the handover command message comprises RACH-ConfigDedicated configuration information, then the RACH-ConfigDedicated configuration information is valid for a determined target anchor carrier or non-anchor carrier. In this case, step S720 can comprise: receiving a preamble and/or an MSG3 message from the UE on an uplink carrier associated with the determined target anchor carrier or non-anchor carrier; and sending an RAR and/or an MSG4 message to the UE on a downlink carrier associated with the determined target anchor carrier or non-anchor carrier.

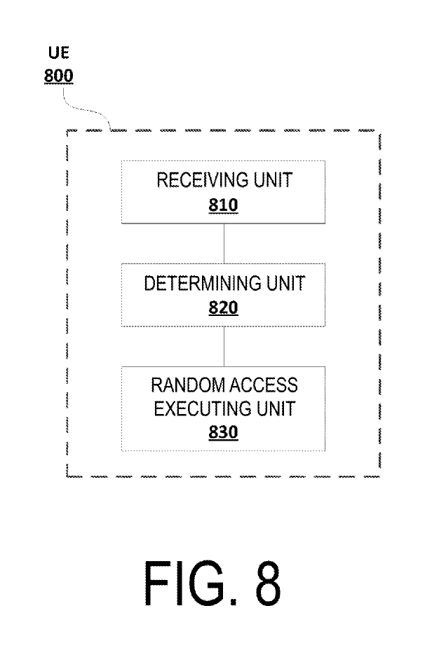

A UE according to an embodiment of the present invention will be described below with reference to FIG. 8. FIG. 8 schematically illustrates a structural block diagram of a UE 800 according to an embodiment of the present invention. The UE 800 can perform the method for random access according to the embodiment of the present invention, for example, the method 500 described in detail previously as shown in FIG. 5.

As shown in FIG. 8, the UE 800 comprises a receiving unit 810, a determining unit 820, and a random access executing unit 830. Those skilled in the art should understand that only the receiving unit 810, the determining unit 820, and the random access executing unit 830 related to the present invention are shown in the UE 800 of FIG. 8 to avoid confusion of the present invention. However, those skilled in the art should understand that although not shown in FIG. 8, the UE according to the embodiment of the present invention further comprises other basic units that form the UE.

The receiving unit 810 is used for receiving a handover command message from a source base station. The handover command message comprises information about a target anchor carrier.

The determining unit 820 is used for determining whether to use the target anchor carrier or a non-anchor carrier for random access based on the handover command message.

The random access executing unit 830 is used for performing random access by using the target anchor carrier or the non-anchor carrier according to a determination result.

In one implementation, the determining unit 820 is further used for: if the handover command message does not comprise non-anchor carrier configuration information about a target non-anchor carrier, determining to use the target anchor carrier for random access.

In one implementation, the determining unit 820 is further used for: if the handover command message comprises the non-anchor carrier configuration information about the target non-anchor carrier and the handover command message or target cell system information does not comprise random access configuration information corresponding to the target non-anchor carrier, determining to use the target anchor carrier for random access.

In one implementation, the determining unit 820 is further used for: if the handover command message comprises the non-anchor carrier configuration information about the target non-anchor carrier and the target non-anchor carrier indicated by the non-anchor carrier configuration information does not support random access, determining to use the target anchor carrier for random access.

In one implementation, the determining unit 820 is further used for: if the handover command message comprises the non-anchor carrier configuration information about the target non-anchor carrier and the handover command message or the target cell system information comprises the random access configuration information corresponding to the target non-anchor carrier, determining to use the target non-anchor carrier for random access.

In one implementation, the determining unit 820 is further used for: if the handover command message comprises the non-anchor carrier configuration information about the target non-anchor carrier and the target non-anchor carrier indicated by the non-anchor carrier configuration information supports random access, determining to use the target non-anchor carrier for random access.

In one implementation, the determining unit 820 is further used for: if the handover command message comprises the non-anchor carrier configuration information about the target non-anchor carrier, determining to use the target non-anchor carrier for random access.

In one implementation, the determining unit 820 is further used for: if the handover command message comprises the non-anchor carrier configuration information about the target non-anchor carrier, the handover command message or the target cell system information indicates that the target anchor carrier does not support random access, and the non-anchor carrier configuration information indicates that the target non-anchor carrier does not support random access, selecting one non-anchor carrier for random access from one or more carriers supporting random access.

In one implementation, the determining unit 820 is further used for: if the handover command message does not comprise the non-anchor carrier configuration information about the target non-anchor carrier and/or the handover command message or the target cell system information indicates that the target anchor carrier does not support random access, selecting one non-anchor carrier for random access from one or more carriers supporting random access.

In one implementation, the determining unit 820 is further used for: if the handover command message comprises the non-anchor carrier configuration information about the target non-anchor carrier and the handover command message or the target cell system information does not comprise the random access configuration information corresponding to the target non-anchor carrier, selecting one non-anchor carrier for random access from one or more carriers supporting random access.

In one implementation, the determining unit 820 is further used for: if the handover command message comprises the non-anchor carrier configuration information about the target non-anchor carrier and the target non-anchor carrier does not support random access, selecting one non-anchor carrier for random access from one or more carriers supporting random access.

Optionally, the UE 800 further comprises a releasing unit for the following purpose: when an RRC connection reconfiguration message comprises the mobility control information (mobilitycontrolinfo) information element (optionally, further comprises the fact that the UE can follow a configuration in the message; or optionally, further comprises the fact that the UE is an NB-IoT UE), if the UE is provided with a non-anchor carrier configuration before receiving a handover command, the UE will release its non-anchor carrier related configuration information.

In one implementation, the non-anchor carrier configuration information is contained in a radioresource-configdedicated information element or a physicalconfig-dedicated information element of the handover command message.

In one implementation, the handover command message is an RRC connection reconfiguration message comprising mobility control information.

In one implementation, if the handover command message comprises RACH-ConfigDedicated configuration information, then the RACH-ConfigDedicated configuration information is valid for a determined target anchor carrier or non-anchor carrier. In this case, the random access executing unit 830 is further used for: sending a preamble and/or an MSG3 message to a target base station on an uplink carrier associated with the determined target anchor carrier or non-anchor carrier; and receiving an RAR and/or an MSG4 message from the target base station on a downlink carrier associated with the determined target anchor carrier or non-anchor carrier.

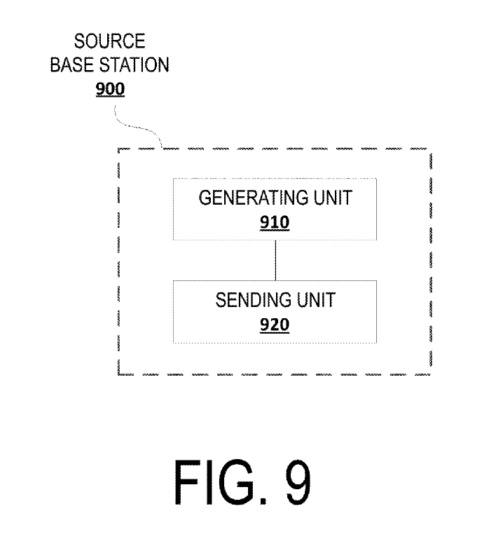

A base station according to an embodiment of the present invention will be described below with reference to FIG. 9. FIG. 9 schematically illustrates a structural block diagram of a source base station 900 according to an embodiment of the present invention. The source base station 900 can perform the method for random access according to the embodiment of the present invention, for example, the method 600 described in detail previously as shown in FIG. 6.

As shown in FIG. 9, the source base station 900 comprises a generating unit 910 and a sending unit 920. Those skilled in the art should understand that only the generating unit 910 and the sending unit 920 related to the present invention are shown in the source base station 900 of FIG. 9 to avoid confusion of the present invention. However, those skilled in the art should understand that although not shown in FIG. 9, the base station according to the embodiment of the present invention further comprises other basic units that form the base station.

The generating unit 910 is used for generating a handover command message. The handover command message comprises information about a target anchor carrier, or the handover command message comprises the information about the target anchor carrier and non-anchor carrier configuration information about a target non-anchor carrier.

The sending unit 920 is used for sending the handover command message to a UE, so that the UE performs random access by using the target anchor carrier, the target non-anchor carrier, or a non-anchor carrier selected from one or more carriers supporting random access

In one implementation, the non-anchor carrier configuration information is contained in a radioresource-configdedicated information element or a physicalconfig-dedicated information element of the handover command message.

In one implementation, the handover command message is an RRC connection reconfiguration message comprising mobility control information.

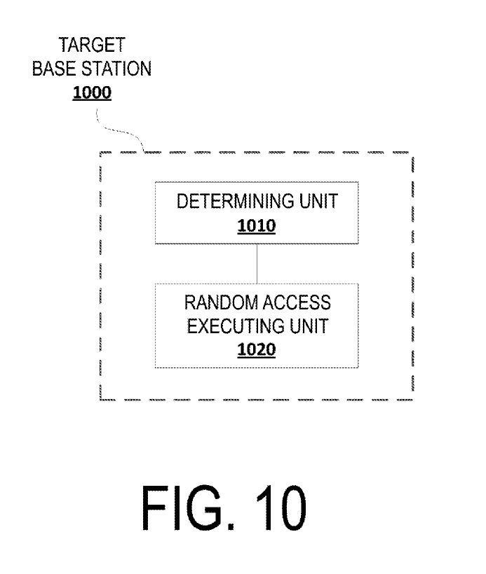

A base station according to an embodiment of the present invention will be described below with reference to FIG. 10. FIG. 10 schematically illustrates a structural block diagram of a target base station 1000 according to an embodiment of the present invention. The target base station 1000 can perform the method for random access according to the embodiment of the present invention, for example, the method 700 described in detail previously as shown in FIG. 7.

As shown in FIG. 10, the target base station 1000 comprises a determining unit 1010 and a random access executing unit 1020. Those skilled in the art should understand that only the determining unit 1010 and the random access executing unit 1020 related to the present invention are shown in the target base station 1000 of FIG. 10 to avoid confusion of the present invention. However, those skilled in the art should understand that although not shown in FIG. 10, the base station according to the embodiment of the present invention further comprises other basic units that form the base station.

The determining unit 1010 is used for determining whether to receive random access from a UE on a target anchor carrier or a non-anchor carrier based on handover related information. The handover related information comprises information about the target anchor carrier.

The random access executing unit 1020 is used for receiving or responding to the random access from the UE on the target anchor carrier or the non-anchor carrier according to a determination result.

In one implementation, the determining unit 1010 is further used for: if the handover related information does not comprise non-anchor carrier configuration information about a target non-anchor carrier, determining to receive or respond to the random access on the target anchor carrier.

In one implementation, the determining unit 1010 is further used for: if a handover command message comprises the non-anchor carrier configuration information about the target non-anchor carrier and the handover related information or target cell system information does not comprise random access configuration information corresponding to the target non-anchor carrier, determining to receive or respond to the random access on the target anchor carrier.

In one implementation, the determining unit 1010 is further used for: if the handover related information comprises the non-anchor carrier configuration information about the target non-anchor carrier and the target non-anchor carrier indicated by the non-anchor carrier configuration information does not support random access, determining to receive or respond to the random access on the target anchor carrier.

In one implementation, the determining unit 1010 is further used for: if the handover related information comprises the non-anchor carrier configuration information about the target non-anchor carrier and the handover related information or the target cell system information comprises the random access configuration information corresponding to the target non-anchor carrier, determining to receive or respond to the random access on the target non-anchor carrier.

In one implementation, the determining unit 1010 is further used for: if the handover command message comprises the non-anchor carrier configuration information about the target non-anchor carrier and the target non-anchor carrier indicated by the non-anchor carrier configuration information supports random access, determining to receive or respond to the random access on the target non-anchor carrier.

In one implementation, the determining unit 1010 is further used for: if the handover command message comprises the non-anchor carrier configuration information about the target non-anchor carrier, determining to receive or respond to the random access on the target non-anchor carrier.

In one implementation, the determining unit 1010 is further used for: if the handover related information comprises the non-anchor carrier configuration information about the target non-anchor carrier, the handover related information or the target cell system information indicates that the target anchor carrier does not support random access, and the non-anchor carrier configuration information indicates that the target non-anchor carrier does not support random access, receiving or responding to the random access on one non-anchor carrier supporting random access.

In one implementation, the determining unit 1010 is further used for: if the handover related information does not comprise the non-anchor carrier configuration information about the target non-anchor carrier and/or the handover command message or the target cell system information indicates that the target anchor carrier does not support random access, receiving or responding to the random access on one non-anchor carrier supporting random access.

In one implementation, the determining unit 1010 is further used for: if the handover related information comprises the non-anchor carrier configuration information about the target non-anchor carrier and the handover related information or the target cell system information does not comprise the random access configuration information corresponding to the target non-anchor carrier, receiving or responding to the random access on one non-anchor carrier supporting random access.

In one implementation, the determining unit 1010 is further used for: if the handover command message comprises the non-anchor carrier configuration information about the target non-anchor carrier and the target non-anchor carrier does not support random access, receiving or responding to the random access on one non-anchor carrier supporting random access.

In one implementation, if the handover command message comprises RACH-ConfigDedicated configuration information, then the RACH-ConfigDedicated configuration information is valid for a determined target anchor carrier or non-anchor carrier. In this case, the random access executing unit 1020 is further used for: receiving a preamble and/or an MSG3 message from the UE on an uplink carrier associated with the determined target anchor carrier or non-anchor carrier; and sending an RAR and/or an MSG4 message to the UE on a downlink carrier associated with the determined target anchor carrier or non-anchor carrier.

The specific implementation manners of the present invention are disclosed in detail above with reference to the accompanying drawings; and the manners in which the principle of the present invention is employed are illustrated. It should be understood that the embodiments of the present invention are not limited in scope. Within the spirit and scope defined by the appended claims, the embodiments of the present invention may include various variations, modifications, and equivalents.

The features described and/or illustrated with respect to a specific embodiment may be used in one or more other embodiments in the same or similar manner, or may be combined with the features in other embodiments, or may be used to replace the features in other embodiments.

It should be particularly noted that the term “comprise/include” used herein in this text refer to the existence of the features, whole pieces, steps or components, but do not exclude the existence or addition of one or more of other features, whole pieces, steps, or components.

The program running on the device according to the present invention may be a program that enables the computer to implement the functions of the embodiments of the present invention by controlling the central processing unit (CPU). The program or information processed by the program can be stored temporarily in a volatile memory (e.g., a random access memory RAM), a hard disk drive (HDD), a non-volatile memory (e.g., a flash memory), or other memory systems.

The program for implementing the functions of the embodiments of the present invention may be recorded on a computer-readable recording medium. The corresponding functions can be achieved by reading programs recorded on the recording medium and executing them by the computer system. The so-called “computer system” may be a computer system embedded in the device, which may include operating systems or hardware (e.g., peripherals). The “computer-readable recording medium” may be a semiconductor recording medium, an optical recording medium, a magnetic recording medium, a short-time dynamic memory program, or any other recording medium readable by a computer.

Various features or functional modules of the device used in the above embodiments may be implemented or performd by circuits (e.g., monolithic or multi-chip integrated circuits). Circuits designed to perform the functions described in this description may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, a controller, a microcontroller, or a state machine. The circuit may be a digital circuit or an analog circuit. When new integrated circuit technologies that replace existing integrated circuits emerge because of the advances in semiconductor technology, one or more embodiments of the present invention may also be implemented using these new integrated circuit technologies.

Furthermore, the present invention is not limited to the embodiments described above. Although various examples of the described embodiments have been described, the present invention is not limited thereto. Fixed or non-mobile electronic devices installed indoors or outdoors, such as AV equipment, kitchen equipment, cleaning equipment, air conditioner, office equipment, vending machines, and other household appliances, may be used as terminal devices or communications devices.

The embodiments of the present invention have been described in detail above with reference to the accompanying drawings. However, the specific structures are not limited to the above embodiments, and the present invention also includes any design modifications that do not depart from the main idea of the present invention. In addition, various modifications can be made to the present invention within the scope of the claims, and embodiments resulting from the appropriate combination of the technical means disclosed in different embodiments are also included within the technical scope of the present invention. In addition, components with the same effect described in the above embodiments may be replaced with one another.

1. A method for execution of random access at a user equipment (UE), comprising:
receiving a handover command message from a source base station, the handover command message comprising information about a target anchor carrier;
determining whether to use the target anchor carrier or a non-anchor carrier for random access based on the handover command message; and
performing random access by using the target anchor carrier or the non-anchor carrier according to the determination result.

2-14. (canceled)

15. A method for execution of random access at a source base station, comprising:
generating a handover command message, the handover command message comprising information about a target anchor carrier, or the handover command message comprising the information about the target anchor carrier and non-anchor carrier configuration information about a target non-anchor carrier; and
sending the handover command message to a user equipment (UE), so that the UE performs random access by using the target anchor carrier, the target non-anchor carrier, or a non-anchor carrier selected from one or more carriers supporting random access.

16-17. (canceled)

18. A method for execution of random access at a target base station, comprising:
determining whether to receive random access from a user equipment (UE) on a target anchor carrier or a non-anchor carrier based on handover related information, the handover related information comprising information about the target anchor carrier; and
receiving or responding to the random access from the UE on the target anchor carrier or the non-anchor carrier according to the determination result.

19-29. (canceled)

30. A user equipment (UE), comprising:
a receiving unit for receiving a handover command message from a source base station, the handover command message comprising information about a target anchor carrier;
a determining unit for determining whether to use the target anchor carrier or a non-anchor carrier for random access based on the handover command message; and
a random access executing unit for performing random access by using the target anchor carrier or the non-anchor carrier according to a determination result.

31. The UE according to claim 30, wherein the determining unit is further used for:
if the handover command message does not comprise non-anchor carrier configuration information about a target non-anchor carrier, determining to use the target anchor carrier for random access.

32. The UE according to claim 30, wherein the determining unit is further used for:
if the handover command message comprises non-anchor carrier configuration information about a target non-anchor carrier and the handover command message or target cell system information does not comprise random access configuration information corresponding to the target non-anchor carrier, determining to use the target anchor carrier for random access.

33. The UE according to claim 30, wherein the determining unit is further used for:
if the handover command message comprises non-anchor carrier configuration information about a target non-anchor carrier and the target non-anchor carrier indicated by the non-anchor carrier configuration information does not support random access, determining to use the target anchor carrier for random access.

34. The UE according to claim 30, wherein the determining unit is further used for:
if the handover command message comprises non-anchor carrier configuration information about a target non-anchor carrier and the handover command message or target cell system information comprises random access configuration information corresponding to the target non-anchor carrier, determining to use the target non-anchor carrier for random access.

35. The UE according to claim 30, wherein the determining unit is further used for:
if the handover command message comprises non-anchor carrier configuration information about a target non-anchor carrier and the target non-anchor carrier indicated by the non-anchor carrier configuration information supports random access, determining to use the target non-anchor carrier for random access.

36. The UE according to claim 30, wherein the determining unit is further used for:
if the handover command message comprises non-anchor carrier configuration information about a target non-anchor carrier, determining to use the target non-anchor carrier for random access.

37. The UE according to claim 30, wherein the determining unit is further used for:
if the handover command message comprises non-anchor carrier configuration information about a target non-anchor carrier, the handover command message or target cell system information indicates that the target anchor carrier does not support random access, and the non-anchor carrier configuration information indicates that the target non-anchor carrier does not support random access, selecting one non-anchor carrier for random access from one or more carriers supporting random access.

38. The UE according to claim 30, wherein the determining unit is further used for:
if the handover command message does not comprise non-anchor carrier configuration information about a target non-anchor carrier and/or the handover command message or target cell system information indicates that the target anchor carrier does not support random access, selecting one non-anchor carrier for random access from one or more carriers supporting random access.

39. The UE according to claim 30, wherein the determining unit is further used for:
if the handover command message comprises non-anchor carrier configuration information about a target non-anchor carrier and the handover command message or target cell system information does not comprise random access configuration information corresponding to the target non-anchor carrier, selecting one non-anchor carrier for random access from one or more carriers supporting random access.

40. The UE according to claim 30, wherein the determining unit is further used for:
if the handover command message comprises non-anchor carrier configuration information about a target non-anchor carrier and the target non-anchor carrier does not support random access, selecting one non-anchor carrier for random access from one or more carriers supporting random access.

41. The UE according to claim 31, wherein the non-anchor carrier configuration information is contained in a radioresource-configdedicated information element or a physicalconfig-dedicated information element of the handover command message.

42. The UE according to claim 30, wherein the handover command message is an RRC connection reconfiguration message comprising mobility control information.

43. The UE according to claim 30, wherein if the handover command message comprises RACH-ConfigDedicated configuration information, then the RACH-ConfigDedicated configuration information is valid for a determined target anchor carrier or non-anchor carrier; and the random access executing unit is further used for:
sending a preamble and/or an MSG3 message to a target base station on an uplink carrier associated with the determined target anchor carrier or non-anchor carrier; and
receiving an RAR and/or an MSG4 message from the target base station on a downlink carrier associated with the determined target anchor carrier or non-anchor carrier.

44. A source base station, comprising:
a generating unit for generating a handover command message, the handover command message comprising information about a target anchor carrier, or the handover command message comprising the information about the target anchor carrier and non-anchor carrier configuration information about a target non-anchor carrier; and
a sending unit for sending the handover command message to a user equipment (UE), so that the UE performs random access by using the target anchor carrier, the target non-anchor carrier, or a non-anchor carrier selected from one or more carriers supporting random access.

45-46. (canceled)

47. A target base station, comprising:
a determining unit for determining whether to receive random access from a user equipment (UE) on a target anchor carrier or a non-anchor carrier based on handover related information, the handover related information comprising information about the target anchor carrier; and
a random access executing unit for receiving or responding to the random access from the UE on the target anchor carrier or the non-anchor carrier according to a determination result.

48-58. (canceled)
